(19) United States
(12) Patent Application Publication
(10) Pub. No.: US 2026/0301166 A1
(43) Pub. Date: Oct. 1, 2026

(54) SYSTEM AND METHOD FOR PATHOLOGIC FEATURE DETECTION AND QUANTIFICATION

(71) Applicant: The Cleveland Clinic Foundation, Cleveland, OH (US)

(72) Inventors: Justis P Ehlers, Shaker Heights, OH (US); Sunil K Srivastava, Shaker Heights, OH (US)

(21) Appl. No.: 19/479,250

(22) PCT Filed: Apr. 29, 2024
(86) PCT No.: PCT/US2024/026841

§ 371 Date: Oct. 27, 2025

Related U.S. Application Data
(60) Provisional application No. 63/462,940, filed on Apr. 28, 2023.

(51) Int. Cl. G06T 7/00; G06T 7/11

(52) U.S. Cl. CPC G06T 7/0012; G06T 7/11; G06T 2207/10101; G06T 2207/20081; G06T 2207/20084; G06T 2207/30041

(57) ABSTRACT

One or more computing devices, systems and/or methods are provided. In an example, a set of images of an eye of a person may be identified. The set of images may include an en face optical coherence tomography (OCT) image and an OCT Brightness-scan (B-scan). The en face OCT image may be evaluated using a first machine learning model to generate an en face feature segmentation indicative of one or more areas, of the en face OCT image, corresponding to a first pathological feature. The OCT B-scan may be evaluated using a second machine learning model to generate a B-scan feature segmentation indicative of one or more areas, of the OCT B-scan, corresponding to the first pathological feature. An enhanced pathological feature segmentation indicative of the first pathological feature may be generated based upon the en face feature segmentation and the B-scan feature segmentation.

### RELATED APPLICATION

This application is a national stage application, filed under 35 U.S.C. § 371, of International Patent Application No. PCT/US24/026841, filed on Apr. 29, 2024, which claims priority to U.S. Provisional Patent Application No. 63/462,940, filed on Apr. 28, 2023, entitled “Automated Detection and Quantification of Geographic Atrophy and/or Hypertransmission Defects Using A Deep Learning Platform for SD-OCT Image Characterization.” U.S. Provisional Patent Application No. 63/462,940 and International Patent Application No. PCT/US24/026841 are incorporated herein by reference in their entirety.

### TECHNICAL FIELD

The present disclosure relates to evaluating ocular images.

### BACKGROUND

Eye diseases include various conditions affecting vision, including age-related macular degeneration (AMD), diabetic retinopathy, and other conditions. Early detection of eye diseases through testing is important for managing these conditions effectively. Detecting AMD in its early stages allows for interventions that may slow its progression and preserve vision. Similarly, early detection of diabetic retinopathy enables timely treatment to prevent and/or minimize vision loss.

### SUMMARY

In accordance with the present disclosure, one or more computing devices, systems and/or methods are provided. In an example, a method is provided. A set of images of an eye of a person may be identified. The set of images may include an en face optical coherence tomography (OCT) image and an OCT Brightness-scan (B-scan). The en face OCT image may be evaluated using a first machine learning model to generate an en face feature segmentation indicative of one or more areas, of the en face OCT image, corresponding to a first pathological feature. The OCT B-scan may be evaluated using a second machine learning model to generate a B-scan feature segmentation indicative of one or more areas, of the OCT B-scan, corresponding to the first pathological feature. An enhanced pathological feature segmentation indicative of the first pathological feature may be generated based upon the en face feature segmentation and the B-scan feature segmentation.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4A is a component block diagram illustrating training a machine learning model, in accordance with some embodiments.

FIG. 4B is a component block diagram illustrating training a machine learning model, in accordance with some embodiments.

FIG. 4C is a component block diagram illustrating generation of a ground truth mask for use in training a machine learning model, in accordance with some embodiments.

FIG. 4D illustrates graphical representations associated with generation of a ground truth mask for use in training a machine learning model, in accordance with some embodiments.

FIG. 4E is a component block diagram illustrating generation of an en face image for use in training a machine learning model, in accordance with some embodiments.

FIG. 4F is a component block diagram illustrating generation of an en face ground truth mask for use in training a machine learning model, in accordance with some embodiments.

FIG. 5 is a component block diagram illustrating a system for evaluating ocular images, in accordance with some embodiments.

FIG. 6A is a component block diagram illustrating B-scan to en face translation for generating an enhanced feature segmentation, in accordance with some embodiments.

FIG. 6B is a component block diagram illustrating generation of an enhanced feature segmentation based upon a comparison of en face feature segmentations, in accordance with some embodiments.

FIG. 7 is a component block diagram illustrating en face to B-scan translation for generating an enhanced feature segmentation, in accordance with some embodiments.

FIG. 8 is a component block diagram illustrating lesion size stratification, in accordance with some embodiments.

FIG. 9 illustrates an example representation of at least a portion of an ocular report, in accordance with some embodiments.

FIG. 10 is a flow chart illustrating an example method, in accordance with some embodiments.

FIG. 11 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware, medicine, clothing design, or any combination thereof.

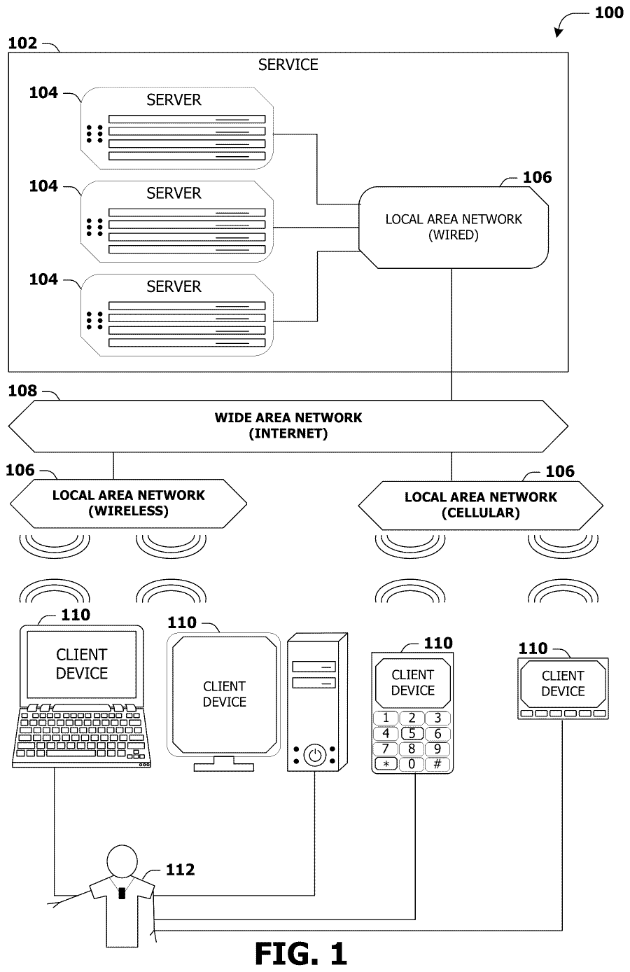

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

In the scenario 100 of FIG. 1, the service 102 may be accessed via a wide area network 108 (WAN) by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108.

One or more client devices 110 may comprise a cellular communicator and may communicate with the service 102 by connecting to the wide area network 108 via a wireless local area network 106 (LAN) provided by a cellular provider.

Alternatively and/or additionally, one or more client devices 110 may communicate with the service 102 by connecting to the wide area network 108 via a wireless local area network 106 provided by a location such as the user's home or workplace. The wireless local area network 106 may, for example, be a WiFi (Institute of Electrical and Electronics Engineers (IEEE) Standard 802.11) network or a Bluetooth (IEEE Standard 802.15.1) personal area network.

It may be appreciated that the servers 104 and the client devices 110 may communicate over various types of networks. Exemplary types of networks that may be accessed by the servers 104 and/or client devices 110 include mass storage, such as network attached storage (NAS), a storage area network (SAN), or other forms of computer or machine readable media.

The servers 104 of the service 102 may be interconnected directly, or through one or more other networking devices, such as routers, switches, and/or repeaters. The servers 104 may utilize a variety of physical networking protocols, such as Ethernet and/or Fiber Channel, and/or logical networking protocols, such as variants of an Internet Protocol (IP), a Transmission Control Protocol (TCP), and/or a User Datagram Protocol (UDP).

The servers 104 of the service 102 may be internally connected via a local area network 106. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

The local area network 106 may be a wired network where network adapters on the respective servers 104 are interconnected via cables (e.g., coaxial and/or fiber optic cabling), and may be connected in various topologies (e.g., buses, token rings, meshes, and/or trees). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art.

Alternatively and/or additionally, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

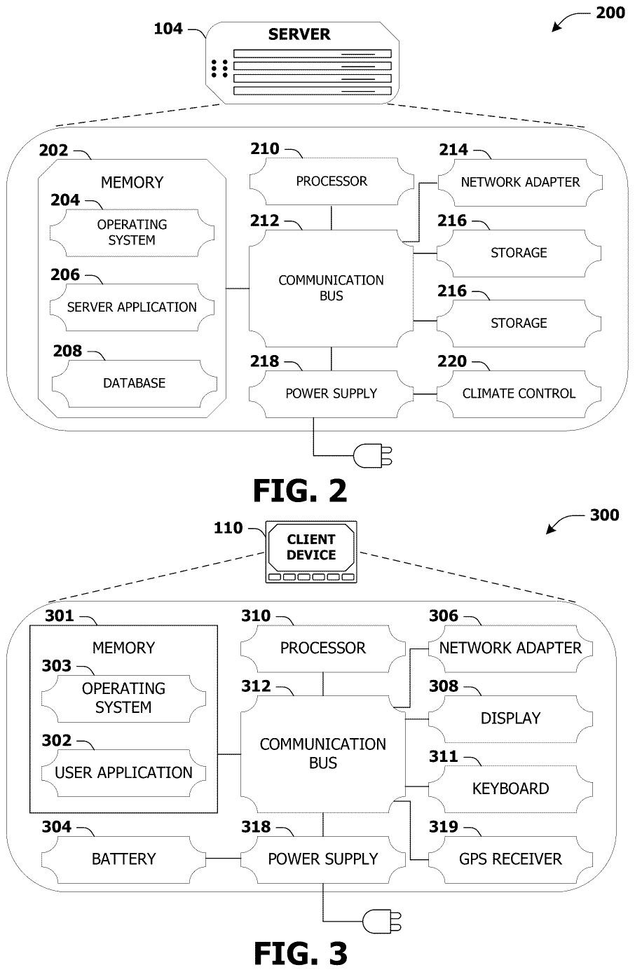

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components.

The server 104 may provide power to and/or receive power from another server and/or other devices. The server 104 may comprise a dedicated and/or shared power supply 218 that supplies and/or regulates power for the other components. The server 104 may comprise a shared and/or dedicated climate control unit 220 that regulates climate properties, such as temperature, humidity, and/or airflow.

The server 104 may include one or more other components that are not shown in the schematic diagram 200 of FIG. 2, such as a display; a display adapter, such as a graphical processing unit (GPU); input peripherals, such as a keyboard and/or mouse; and a flash memory device that may store a basic input/output system (BIOS) routine that facilitates booting the server 104 to a state of readiness. A plurality of such servers 104 may be configured and/or adapted to utilize at least a portion of the techniques presented herein.

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112.

The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals.

In some examples, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified.

In such examples, descriptive content may be stored, typically along with contextual content. For example, the source of an email address (e.g., a communication received from another user via an instant messenger application) may be stored as contextual content associated with the email address. Contextual content, therefore, may identify circumstances surrounding receipt of an email address (e.g., the date or time that the email address was received), and may be associated with descriptive content. Contextual content, may, for example, be used to subsequently search for associated descriptive content. For example, a search for email addresses received from specific individuals, received via an instant messenger application or at a given date or time, may be initiated.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory.

The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol.

The client device 110 may include one or more other components that are not shown in the schematic architecture diagram 300 of FIG. 3, such as one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness. In some examples, the client device 110 may include a climate control unit that regulates climate properties, such as temperature, humidity, and airflow.

The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

The client device 110 may serve the user in a variety of roles, such as a workstation, kiosk, media player, gaming device, and/or appliance. The client device 110 may therefore be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence.

Geographic atrophy (GA) may be a late-stage finding in age-related macular degeneration (AMD) resulting from atrophic changes in the retinal outer layers and/or retinal pigment epithelium (RPE). Progression to GA, particularly subfoveal GA, may result in (permanent, for example) vision loss. GA may have a significant (e.g., an exponential) increase in prevalence with age. In view of the aging population, the number of individuals affected by GA may grow further in the near future.

The irreversible nature of the disease makes monitoring an important part of clinical care of these patients. Optical coherence tomography (OCT) may be a useful tool for identifying and/or monitoring GA. Spectral domain (SD)-OCT, being a three-dimensional imaging technique, may offer several benefits over two-dimensional approaches (like color fundus photography and/or fundus autofluorescence), including thorough characterization of the inner and/or outer retinal layers at high resolution. The use of an en face image may complement the standard cross sectional OCT B-scan allowing for a complete macular review at various depth levels, which may give further anatomic insight into this condition. Complete RPE and Outer Retinal Atrophy (cRORA) may be defined based upon the presence of one, some or all of the following findings on OCT: (i) RPE loss of at least a threshold diameter (e.g., at least 250 micrometers in greatest diameter), (ii) overlying photoreceptor loss, and/or (iii) hypertransmission of at least a threshold diameter (e.g., at least 250 micrometers in greatest diameter). GA lesions not meeting the size criteria may be classified as incomplete RPE and Outer Retinal Atrophy (iRORA).

Accurate and/or reproducible automated detection and/or quantification of GA and/or hypertransmission defects may facilitate clinician identification of patients who may benefit from therapy and/or may enable readily assessing disease progression. Thus, an automated method for identifying, segmenting, and/or quantifying GA, transmission defects and/or other types of pathological features may be beneficial for monitoring patients in clinical practice and/or quantifying the effectiveness of novel treatments in clinical studies, and/or may have the capacity to swiftly and/or reliably extract measurable structural properties of GA that can aid in clinical decision making.

Thus, in accordance with some embodiments, automated approaches to detect the presence of pathological features (e.g., GA transmission defects, etc.) and/or obtain pixel-accurate segmentation of lesions (e.g., GA lesions) using ML-based methods on B-scan images and en face OCT images are provided herein. In an example, an en face OCT image may be evaluated using a first machine learning model (e.g., a trained en face model developed utilizing the interrogation of en face OCT images) to generate an en face feature segmentation indicative of one or more areas, of the en face OCT image, corresponding to one or more first pathological features (e.g., GA and/or a transmission defect, such as a hypertransmission defect and/or a hypotransmission defect). The OCT B-scan may be evaluated using a second machine learning model (e.g., a trained B-scan model developed utilizing the interrogation of OCT B-scans) to generate a B-scan feature segmentation indicative of one or more areas, of the OCT B-scan, corresponding to one or more second pathological features (e.g., the GA and/or the transmission defect). An enhanced pathological feature segmentation indicative of the one or more first pathological features and/or the one or more second pathological features may be generated based upon the en face feature segmentation and the B-scan feature segmentation.

Using one or more of the techniques provided herein may provide for improved accuracy of the enhanced pathological feature segmentation.

The improved accuracy may be due, at least in part, to (i) the first machine learning model using 3-dimensional information represented by the en face OCT image to perform feature segmentation and/or incorporating hypertransmission detection in the feature segmentation and/or (ii) the second machine learning model utilizing architectural and/or anatomic contextual information represented by the OCT B-scan to perform feature segmentation. Thus, the enhanced pathological feature segmentation may be generated to account for both the 3-dimensional information represented by the en face OCT image and the architectural and/or anatomic contextual information represented by the OCT B-scan. Alternatively and/or additionally, B-scans may be more resilient to quality issues compared with en face OCT images, while en face OCT images may be more visually interpretable compared with B-scans. In some examples, the first machine learning model, the second machine learning model and/or one or more other models may be combined to create hybrid outputs for specificity and/or sensitivity detection.

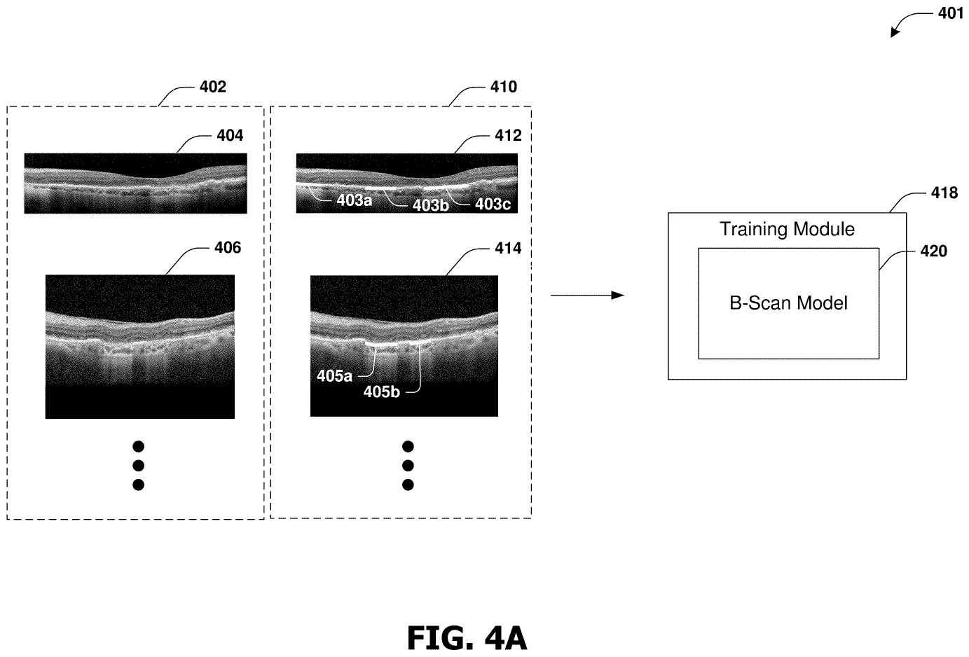

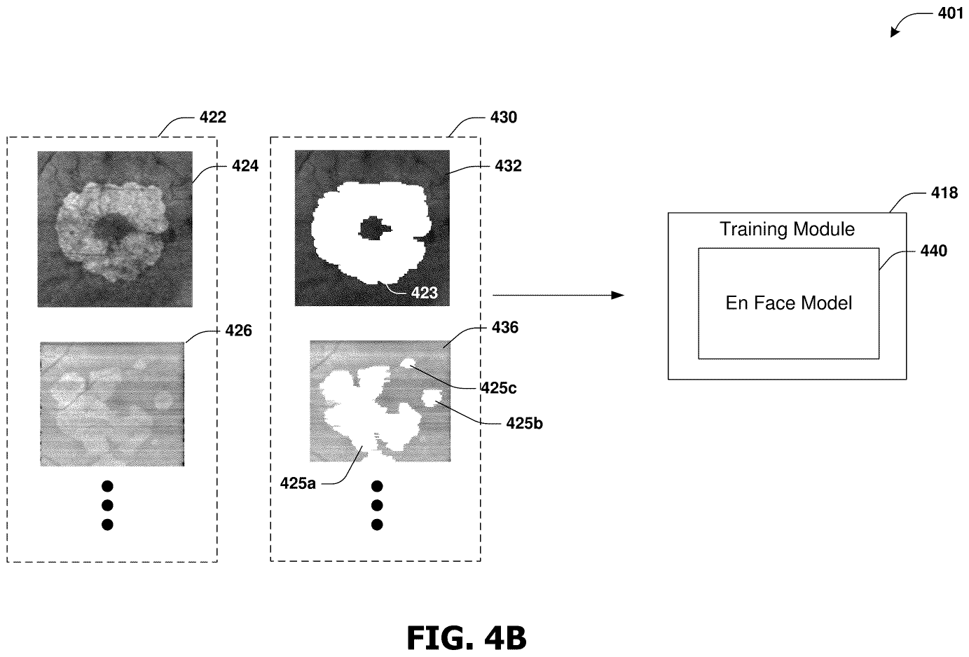

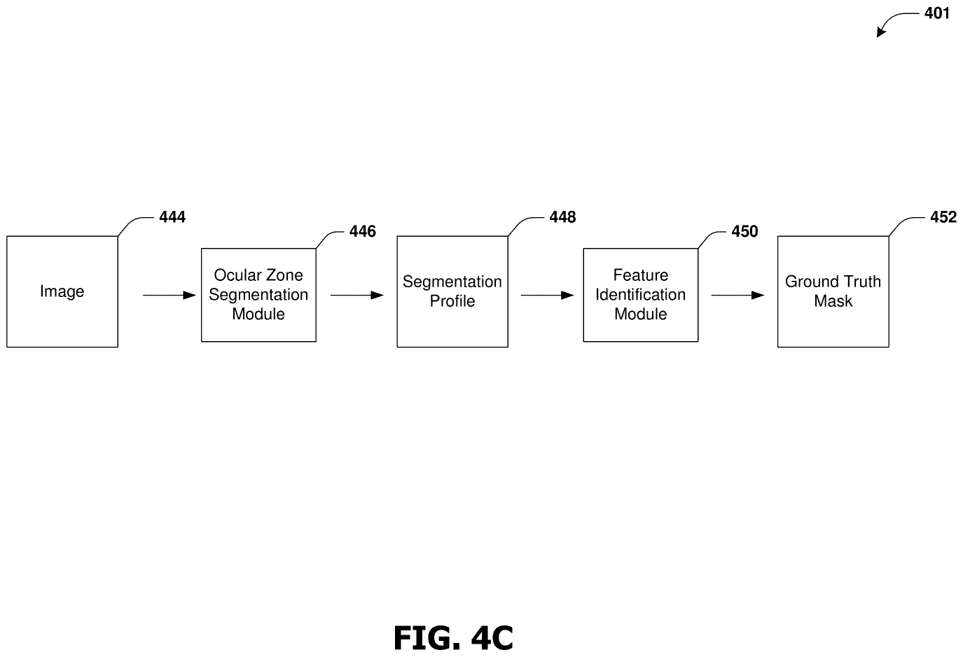

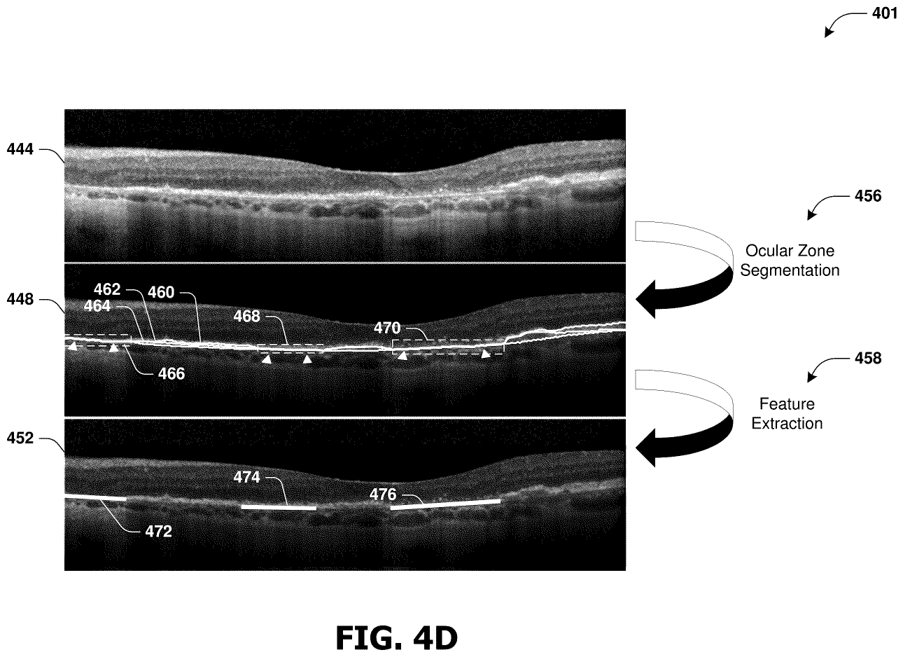

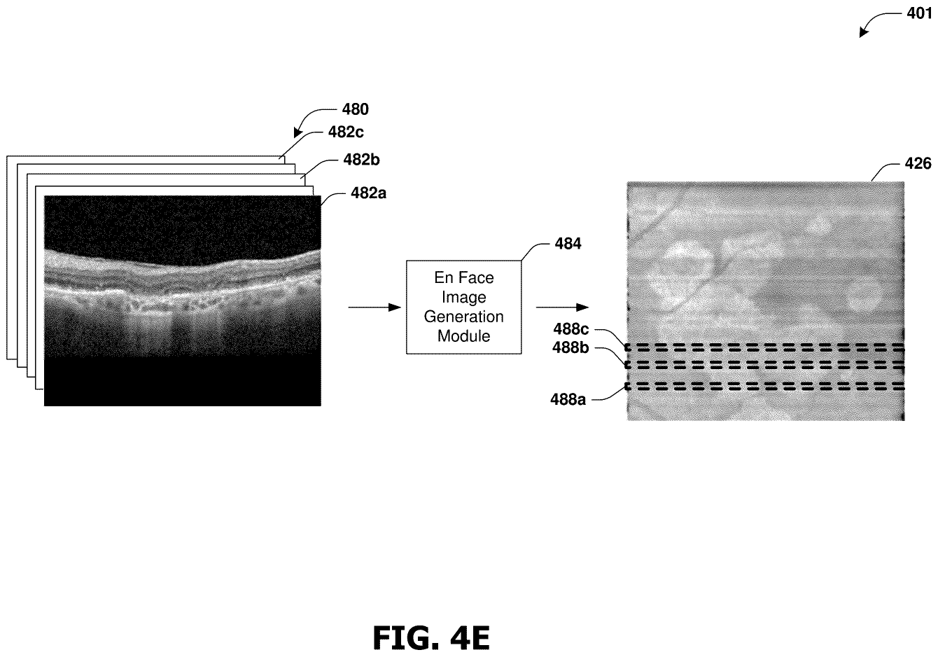

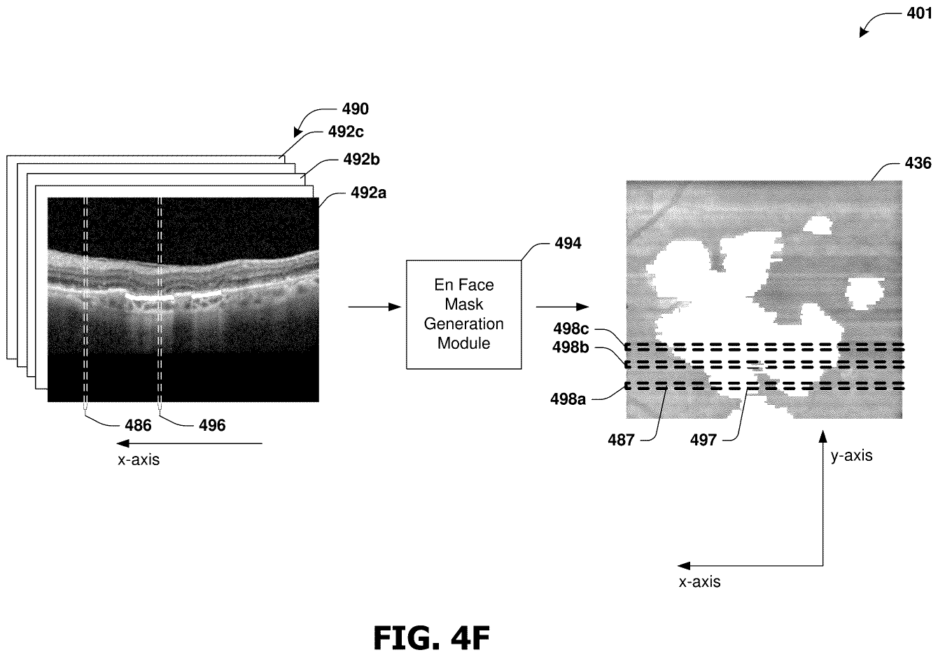

FIGS. 4A-4F illustrate a machine learning model training system 401 training machine learning models of a multi-model ocular evaluation system, in accordance with some embodiments. FIG. 4A illustrates using a training module 418 to train a machine learning model to generate a trained B-scan model 420. In some examples, the training module 418 trains the machine learning model to generate the trained B-scan model 420 using a plurality of Brightness scans (B-scans) 402 and/or a first plurality of ground truth masks 410 associated with the plurality of B-scans 402. The plurality of B-scans 402 may comprise ocular images of a plurality of persons (e.g., persons that are diagnosed with one or more eye conditions and/or persons that are not diagnosed with any eye condition). In some examples, the plurality of B-scans 402 may comprise optical coherence tomography (OCT) B-scans, such as spectral domain OCT (SD-OCT) B-scans. In some examples, an OCT B-scan may comprise a cross-sectional image of a tissue of interest. An OCT B-scan may be a combination of a plurality of OCT Amplitude scans (A-scans) (e.g., the sum of OCT A-scans) which creates the cross-sectional image of a tissue of interest. In some examples, the plurality of B-scans 402 may be adjusted (prior to being used for machine learning model training, for example), such as at least one of resized, cropped, compressed, etc., such that B-scans of the plurality of B-scans 402 have at least one of the same size, the same number of pixels, the same dimensions, etc. In an example, each image of one, some or all of the plurality of B-scans 402 may be automatically adjusted to have the same size (e.g., 128×128 pixels, 512×512 pixels, and/or 256×256 pixels).

In some examples, the trained B-scan model 420 is trained to perform a feature segmentation task comprising identifying one or more pathological features within an image (e.g., distinguish one or more segments of the image that correspond to the one or more pathological features from the rest of the image). In some examples, a pathological feature may be associated with a defined impact on one or more ocular zones (e.g., one or more ocular layers of an eye of a person) and/or one or more retinal compartment zones (e.g., one or more retinal compartment layers of the eye of the person). In some examples, the trained B-scan model 420 is trained to identify one or more first pathological feature types. In some examples, the one or more first pathological feature types comprise at least one of geographic atrophy (GA), a hypertransmission defect, a hypotransmission defect, drusen (e.g., extracellular deposits of lipids, proteins, and/or cellular debris found within one or more layers of a retina), inflammatory lesion, Subretinal material (SRMat), subretinal hyperreflective material (SHRM), ellipsoid zone (EZ) loss, intraretinal fluid (IRF) (e.g., longitudinal IRF), subretinal fluid (SRF) (e.g., longitudinal SRF), cystic fluid, general fluid, sub-RPE fluid, a lesion, etc.

In some examples, masks of the first plurality of ground truth masks 410 may identify segments of respective B-scans of the plurality of B-scans 402 that correspond to pathological features of the one or more first pathological feature types. The plurality of B-scans 402 may comprise an image 404, an image 406 and/or one or more other images. In an example, the one or more first pathological feature types comprise geographic atrophy (GA). The first plurality of ground truth masks 410 may comprise (i) a ground truth mask 412 identifying one or more segments (e.g., segments 403a, 403b and/or 403c shown in white in FIG. 4A), of the image 404, corresponding to GA and/or (ii) a ground truth mask 414 identifying one or more segments (e.g., segments 405a and/or 405b shown in white in FIG. 4A), of the image 406, corresponding to GA.

FIG. 4B illustrates training a machine learning model to generate a trained en face model 440. In some examples, the training module 418 trains the machine learning model to generate the trained en face model 440 using a plurality of en face images 422 (e.g., en face OCT images) and/or a second plurality of ground truth masks 430 associated with the plurality of en face images 422. The plurality of en face images 422 may comprise ocular images of a plurality of persons (e.g., persons that are diagnosed with one or more eye conditions and/or persons that are not diagnosed with any eye condition). In some examples, the plurality of en face images 422 may comprise OCT en face images, such as SD-OCT en face images. In some examples, a plurality of OCT images (e.g., a plurality of OCT B-scans) may be reconstructed to generate an en face image of the plurality of en face images 422. An en face image may also be referred to as a coronal scan (C-scan). In some examples, the plurality of en face images 422 may be adjusted (prior to being used for machine learning model training, for example), such as at least one of resized, cropped, compressed, etc., such that images of the plurality of en face images 422 have at least one of the same size, the same number of pixels, the same dimensions, etc.

In some examples, the trained en face model 440 is trained to perform a feature segmentation task comprising identifying one or more pathological features within an image (e.g., distinguish one or more segments of the image that correspond to the one or more pathological features from the rest of the image). In some examples, the trained en face model 440 is trained to identify one or more second pathological feature types. In some examples, the one or more second pathological feature types comprise at least one of GA, a hypertransmission defect, a hypotransmission defect, drusen, inflammatory lesion, SRMat, SHRM, EZ loss, IRF, SRF, cystic fluid, general fluid, sub-RPE fluid, a lesion, etc. The one or more second pathological feature types may be the same as or different than the one or more first pathological feature types.

In some examples, masks of the second plurality of ground truth masks 430 may identify segments of respective en face images of the plurality of en face images 422 that correspond to pathological features of the one or more second pathological feature types. The plurality of en face images 422 may comprise an en face image 424, an en face image 426 and/or one or more other en face images. In an example, the one or more second pathological feature types comprise geographic atrophy (GA) and/or hypertransmission defect. The second plurality of ground truth masks 430 may comprise (i) an en face ground truth mask 432 identifying one or more segments (e.g., segment 423 shown in white in FIG. 4B), of the en face image 424, corresponding to GA and/or hypertransmission defect and/or (ii) an en face ground truth mask 436 identifying one or more segments (e.g., segments 425a, 425b and/or 425c shown in white in FIG. 4B), of the en face image 426, corresponding to GA and/or hypertransmission defect.

FIG. 4C illustrates generation of a ground truth mask 452 (e.g., a ground truth mask of the first plurality of ground truth masks 410 and/or the second plurality of ground truth masks 430) using an ocular zone segmentation module 446 and/or a feature identification module 450. In an example, the ocular zone segmentation module 446 may evaluate an image 444 (e.g., a B-scan of the plurality of B-scans 402) to generate a segmentation profile 448 indicative of a plurality of segments corresponding to a plurality of ocular zones of an eye of a person. The plurality of segments may comprise line segmentations corresponding to boundaries of ocular zones and/or region of interest segmentations corresponding to regions associated with ocular zones. The plurality of segments may comprise a first segment (e.g., a line segmentation and/or region of interest segmentation) corresponding to a first ocular zone of the plurality of ocular zones, a second segment (e.g., a line segmentation/or region of interest segmentation) corresponding to a second ocular zone, a third segment (e.g., a line segmentation/or region of interest segmentation) corresponding to a third ocular zone and/or one or more other segments (e.g., line segmentations and/or region of interest segmentations) corresponding to one or more other ocular zones of the eye. The plurality of ocular zones may comprise at least one of an internal limiting membrane (ILM), a Bruch's membrane (BM), a retinal pigment epithelium (RPE), an outer nuclear layer (ONL), an ellipsoid zone (EZ), photoreceptor outer segments (POS), an external limiting membrane (ELM), an outer plexiform layer (OPL), an inner nuclear layer (INL), an inner plexiform layer (IPL), a ganglion cell layer (GCL), a retinal nerve fiber layer (RNFL), etc. of the eye of the person.

The segmentation profile 448 may be provided to the feature identification module 450. The feature identification module 450 may (i) evaluate the image 444 to identify one or more segments, of the image 444, corresponding to one or more pathological feature types (e.g., the one or more first pathological feature types and/or the one or more second pathological feature types) and/or (ii) generate the ground truth mask 452 to be indicative of the one or more segments corresponding to the one or more pathological feature types.

FIG. 4D illustrates example representations of the image 444, the segmentation profile 448 and/or the ground truth mask 452. The ocular zone segmentation module 446 may perform ocular zone segmentation 456 to identify the first segment (shown with reference number 460) corresponding to ellipsoid zone (EZ), the second segment (shown with reference number 462) corresponding to retinal pigment epithelium (RPE) and/or the third segment (shown with reference number 464) corresponding to Bruch's membrane (BM). In some examples, the feature identification module 450 may perform feature extraction 458 based upon the segmentation profile 448 to generate the ground truth mask 452. In an example, the feature identification module 450 may analyze the segmentation profile 448 to identify a set of regions in which some or all segments of the first segment 460, the second segment 462 and/or the third segment 464 are confluent (e.g., overlap with each other). For example, the set of regions may comprise (i) a first region 466 in which the first segment 460, the second segment 462 and the third segment 464 are confluent (e.g., overlap), (ii) a second region 468 in which the first segment 460, the second segment 462 and the third segment 464 are confluent (e.g., overlap) and/or (iii) a third region 470 in which the first segment 460, the second segment 462 and the third segment 464 are confluent (e.g., overlap). In some examples, the ground truth mask 452 may be indicative of one or more areas of geographic atrophy (GA) throughout the image 444. An area of GA may correspond to an area where (i) EZ thickness of the EZ of an eye is about 0 or less than a threshold EZ thickness, (ii) RPE thickness of the RPE of the eye is about 0 or less than a threshold RPE thickness, and/or (iii) BM thickness of the BM of the eye is about 0 or less than a threshold BM thickness. The feature identification module 450 may identify GA based upon identification of an area where EZ, RPE and/or BM are confluent (e.g., an area where some or all of EZ, RPE and/or BM overlap with each other). Accordingly, the ground truth mask 452 may be generated to be indicative of segments corresponding to regions of the set of regions. For example, the ground truth mask 452 may be indicative of segments 472, 474 and/or 476 corresponding to areas of GA.

FIG. 4E illustrates generation of the en face image 426 of the plurality of en face images 422 used to train the trained en face model 440. A plurality of OCT images 480 (e.g., a plurality of OCT B-scans) may be reconstructed by an en face image generation module 484 to generate the en face image 426. In some examples, at least some of the plurality of OCT images 480 may be from the plurality of B-scans 402 used to train the trained B-scan model 420. The plurality of OCT images 480 may comprise a B-scan 482a, a B-scan 482b, a B-scan 482c and/or other B-scans. In some examples, the plurality of OCT images 480 may be associated with a macular region (e.g., an OCT macular cube and/or rectangular prism) of an eye. For example, the plurality of OCT images 480 may comprise B-scans corresponding to cross-sectional views, of the eye, throughout the macular region. The macular region may correspond to at least a portion of the eye. In some examples, the en face image generation module 484 may generate the en face image 426 by computing an en face projection of at least a portion of the macular region. For example, the en face image 426 may comprise an en face projection of an entirety of the macular region (without any custom segmentation slabs, for example). Alternatively and/or additionally, the en face image generation module 484 may generate the en face image 426 based upon one or more targeted areas of interest, such as at least one of a subretinal slab, a retinal slab, a sub-RPE slab, a boundary-specific slab that encompasses one or more ocular zones (e.g., one or more anatomic layers of interest), etc. For example, the en face image generation module 484 may generate the en face image 426 to comprise an en face projection of the one or more targeted areas of interest of the macular region. The en face image 426 may comprise a visual representation of the one or more targeted areas of interest over two lateral dimensions (rather than a single lateral dimension corresponding to an OCT B-scan, for example).

In some examples, each of the plurality of OCT images 480 may be used to generate a section of the en face image 426. For example, the B-scan 482a may correspond to a first section 488a of the en face image 426 (e.g., the first section 488a may be generated based upon the B-scan 482a), the B-scan 482b may correspond to a second section 488b of the en face image 426 (e.g., the second section 488b may be generated based upon the B-scan 482b) and/or the B-scan 482c may correspond to a third section 488c of the en face image 426 (e.g., the third section 488c may be generated based upon the B-scan 482c). In some examples, the first section 488a may correspond to one or more first rows of pixels of the en face image 426 (e.g., a single row of pixels, two rows of pixels, etc.), the second section 488b may correspond to one or more second rows of pixels of the en face image 426 and/or the third section 488c may correspond to one or more third rows of pixels of the en face image 426.

FIG. 4F illustrates generation of the en face ground truth mask 436 (associated with the en face image 426) used to train the trained en face model 440. In some examples, a plurality of B-scan ground truth masks 490 associated with the plurality of OCT images 480 may be assembled by an en face mask generation module 494 to generate the en face ground truth mask 436. Each mask of the plurality of B-scan ground truth masks 490 may identify one or more segments, of an image (e.g., a B-scan) of the plurality of OCT images 480, corresponding to the one or more first pathological feature types. In some examples, at least some of the plurality of B-scan ground truth masks 490 may be from the first plurality of ground truth masks 410 (associated with the plurality of B-scans 402) used to train the trained B-scan model 420. The plurality of B-scan ground truth masks 490 may comprise (i) a B-scan ground truth mask 492a indicative of one or more segments, of the B-scan 482a (shown in FIG. 4E), corresponding to GA, (ii) a B-scan ground truth mask 492b indicative of one or more segments, of the B-scan 482b, corresponding to GA, (iii) a B-scan ground truth mask 492c indicative of one or more segments, of the B-scan 482c, corresponding to GA and/or (iv) other B-scan ground truth masks. In some examples, horizontal dimensions of each mask of one, some or all of the plurality of B-scan ground truth masks 490 may be sized to fit a width of an en face scan (e.g., an original en face scan, such as the en face image 426). In some examples, vertical rescaling from the plurality of B-scan ground truth masks 490 to the en face ground truth mask 436 may not be necessary since each B-scan corresponds to a single vertical pixel of the en face image 426 (and/or each B-scan ground truth mask corresponds to a single vertical pixel of the en face ground truth mask 436). Embodiments are contemplated in which vertical rescaling is performed and/or a B-scan corresponds to more than one vertical pixel of the en face image 426.

In some examples, each of the plurality of B-scan ground truth masks 490 may be used to generate a section of the en face ground truth mask 436. For example, the B-scan ground truth mask 492a may be used to generate a first section 498a of the en face ground truth mask 436, the B-scan ground truth mask 492b may be used to generate a second section 498b of the en face ground truth mask 436 and/or the B-scan ground truth mask 492c may be used to generate a third section 498c of the en face ground truth mask 436. In some examples, the first section 488a may correspond to one or more rows of pixels of the en face ground truth mask 436 (e.g., a single row of pixels, two rows of pixels, etc.). In an example in which each B-scan corresponds to a single vertical pixel of the en face image 426 (and/or each B-scan ground truth mask corresponds to a single vertical pixel of the en face ground truth mask 436), the first section 488a may comprise a single row of pixels (the first section 488a may span a single vertical pixel on the y-axis shown in FIG. 4F), and/or each y-coordinate of the en face ground truth mask 436 along the y-axis may correspond to a B-scan ground truth mask of the plurality of B-scan ground truth masks 490. In some examples, for each x coordinate of the first section 498a of the en face ground truth mask 436 along the x-axis, the en face mask generation module 494 may generate a pixel at the x coordinate based upon one or more values, of the B-scan ground truth mask 492a, associated with the x coordinate. For example, a pixel 487 at a first x-coordinate of the first section 498a of the en face ground truth mask 436 may be generated based upon a first set of values (e.g., a column of pixels 486), of the B-scan ground truth mask 492a, corresponding to the first x-coordinate. In an example, the pixel 487 may be generated based upon a maximum value of the first set of values. In some examples, the pixel 487 is generated to indicate no GA (e.g., a value of zero) based upon all of the first set of values being equal to zero. Alternatively and/or additionally, a pixel 497 at a second x-coordinate of the first section 498a of the en face ground truth mask 436 may be generated based upon a second set of values (e.g., a column of pixels 496), of the B-scan ground truth mask 492a, corresponding to the second x-coordinate. In an example, the pixel 497 may be generated based upon a maximum value of the second set of values. In some examples, the pixel 497 is generated to indicate presence of GA (e.g., a value of one) based upon at least one value of the second set of values being equal to one.

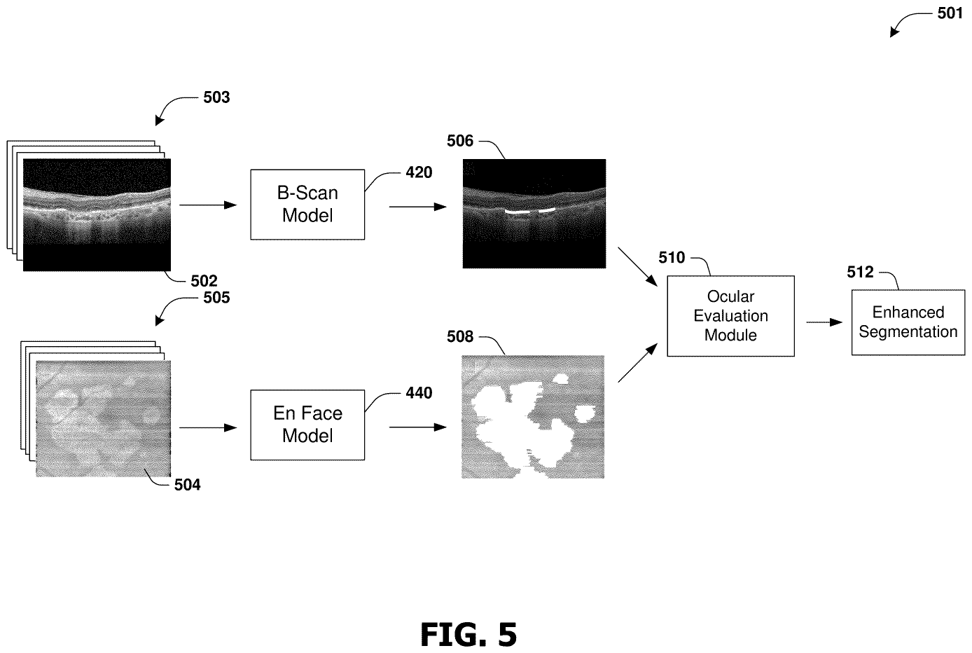

FIG. 5 illustrates a system 501 to evaluate images (e.g., OCT images, such as SD-OCT images) of a first eye of a first person (e.g., a patient). The images may include a set of B-scans 503 (e.g., a set of one or more B-scans) and/or a set of en face images 505 (e.g., a set of one or more en face images). In some examples, one or more B-scans of the set of B-scans 503 may be reconstructed to generate an en face image of the set of en face images 505.

In some examples, the set of B-scans 503 may be provided to the trained B-scan model 420. The trained B-scan model 420 may evaluate a B-scan 502 of the set of B-scans 503 to generate a first B-scan feature segmentation 506 indicative of one or more areas, of the B-scan 502, corresponding to the one or more first pathological feature types. Alternatively and/or additionally, the trained B-scan model 420 may evaluate one or more other B-scans of the set of B-scans 503 to generate one or more other B-scan feature segmentations (not shown) that are each indicative of one or more areas of a B-scan corresponding to the one or more first pathological feature types.

In some examples, the set of en face images 505 may be provided to the trained en face model 440. The trained en face model 440 may evaluate an en face image 504 of the set of en face images 505 to generate a first en face feature segmentation 508 indicative of one or more areas, of the en face image 504, corresponding to the one or more second pathological feature types. Alternatively and/or additionally, the trained en face model 440 may evaluate one or more other en face images of the set of en face images 505 to generate one or more other en face feature segmentations (not shown) that are each indicative of one or more areas of an en face image corresponding to the one or more second pathological feature types.

In some examples, the one or more first pathological feature types associated with the trained B-scan model 420 and the one or more second pathological feature types associated with the trained en face model 440 both comprise a common pathological feature type (e.g., the trained B-scan model 420 and the trained en face model 440 are both trained to identify the common pathological feature type). For example, (i) the first B-scan feature segmentation 506 may be indicative of one or more areas, of the B-scan 502, corresponding to a first pathological feature of the common pathological feature type and/or (ii) the first en face feature segmentation 508 may be indicative of one or more areas, of the en face image 504, corresponding to the first pathological feature. In an example, the common pathological feature type may correspond to GA. For example, the first pathological feature may comprise one or more GA lesions. Accordingly, (i) the first B-scan feature segmentation 506 may be indicative of one or more areas, of the B-scan 502, corresponding to GA and/or (ii) the first en face feature segmentation 508 may be indicative of one or more areas, of the en face image 504, corresponding to GA. In some examples, the first pathological feature comprises a lesion, at one or more ocular zones of the first eye (e.g., one or more ocular zones of the retina and/or one or more other portions of the first eye), associated with at least one of GA, a hypertransmission defect, a hypotransmission defect, drusen, inflammation (e.g., an inflammatory lesion), SRMat, SHRM or ellipsoid zone (EZ) loss.

In some examples, the system 501 may comprise an ocular evaluation module 510 to generate an enhanced pathological feature segmentation 512 based upon the first B-scan feature segmentation 506 and/or the first en face feature segmentation 508. The enhanced pathological feature segmentation 512 may be indicative of the first pathological feature (and/or may be indicative of one or more other pathological features of the one or more first pathological feature types and/or the one or more second pathological feature types).

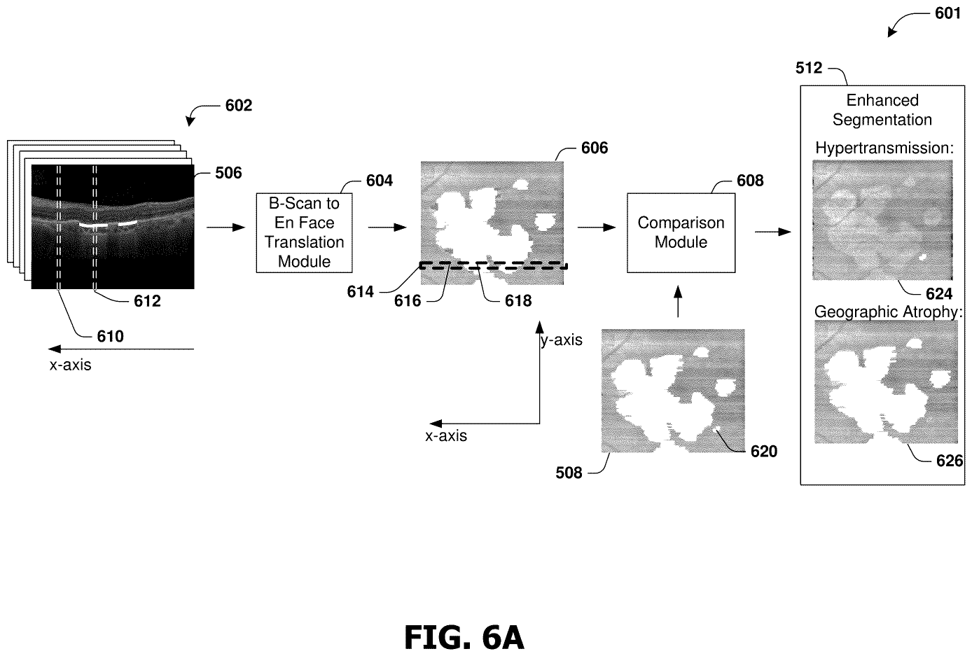

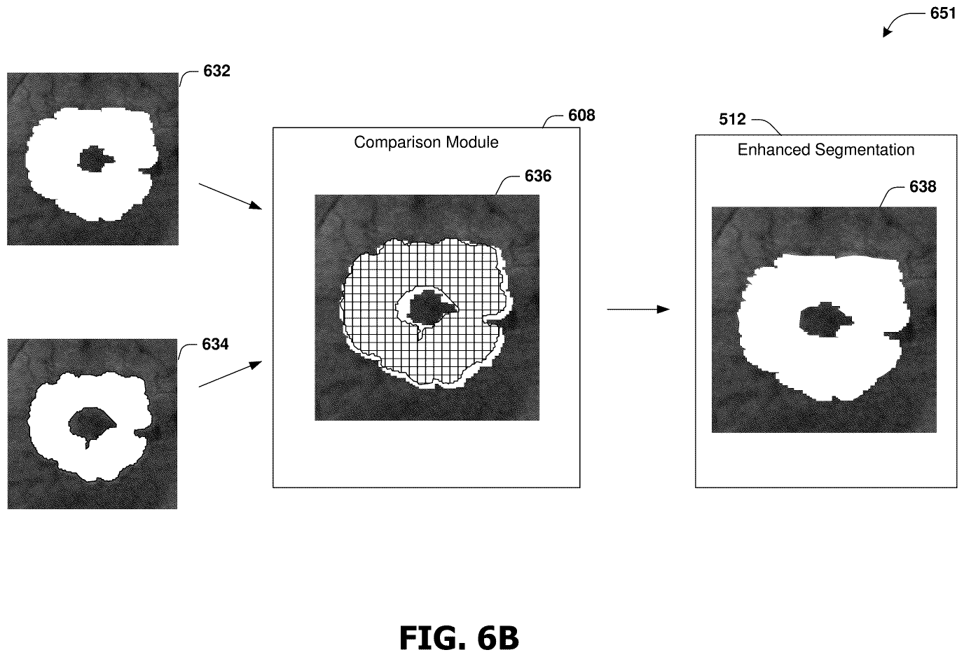

FIG. 6A illustrates an example scenario 601 in which the ocular evaluation module 510 generates a second en face feature segmentation 606 based upon the first B-scan feature segmentation 506, and/or uses the second en face feature segmentation 606 (in conjunction with the first en face feature segmentation 508, for example) to generate the enhanced pathological feature segmentation 512. In some examples, a first translation module 604 translates one or more areas (of the B-scan 502, for example) indicated by the first B-scan feature segmentation 506 to one or more second areas of the en face image 504 to generate the second en face feature segmentation 606.

Alternatively and/or additionally, the first translation module 604 may generate the second en face feature segmentation 606 based upon a first plurality of B-scan feature segmentations 602 comprising the first B-scan feature segmentation 506 associated with the B-scan 502 and/or other B-scan feature segmentations associated with other B-scans of the set of B-scans 503. In some examples, the set of B-scans 503 (and/or the first plurality of B-scan feature segmentations 602) may be associated with a first macular region (e.g., an OCT macular cube and/or rectangular prism) of the first eye. For example, the set of B-scans 503 may comprise B-scans corresponding to cross-sectional views, of the first eye, throughout the first macular region. The first macular region may correspond to at least a portion of the first eye.

In some examples, a generation module (e.g., the en face image generation module 484) may generate the en face image 504 by computing an en face projection of at least a portion of the first macular region. For example, the en face image 504 may comprise an en face projection of an entirety of the first macular region (without any custom segmentation slabs, for example). Alternatively and/or additionally, the generation module may generate the en face image 504 based upon one or more targeted areas of interest, such as at least one of a subretinal slab, a retinal slab, a sub-RPE slab, a boundary-specific slab that encompasses one or more ocular zones (e.g., one or more anatomic layers of interest), etc. For example, the generation module may generate the en face image 504 to comprise an en face projection of the one or more targeted areas of interest of the first macular region. The en face image 504 may comprise a visual representation of the one or more targeted areas of interest.

In some examples, the first plurality of B-scan feature segmentations 602 associated with the set of B-scans 503 may be assembled to generate the second en face feature segmentation 606. In some examples, horizontal dimensions of each feature segmentation of one, some or all of the first plurality of B-scan feature segmentations 602 may be sized to fit a width of an en face scan (e.g., an original en face scan, such as the en face image 504). In some examples, vertical rescaling from the first plurality of B-scan feature segmentations 602 to the second en face feature segmentation 606 may not be necessary since each B-scan corresponds to a single vertical pixel of the en face image 504 (and/or each B-scan feature segmentation corresponds to a single vertical pixel of the second en face feature segmentation 606). Embodiments are contemplated in which vertical rescaling is performed and/or a B-scan corresponds to more than one vertical pixel of the en face image 504.

In some examples, each of the first plurality of B-scan feature segmentations 602 may be used to generate a section of the second en face feature segmentation 606. The first plurality of B-scan feature segmentations 602 may be used to generate the second en face feature segmentation 606 using one or more of the techniques provided herein with respect to using the plurality of B-scan ground truth masks 490 to generate the en face ground truth mask 436. For example, the first B-scan feature segmentation 506 of the first plurality of B-scan feature segmentations 602 may be used to generate a section 614 of the second en face feature segmentation 606. In some examples, the section 614 may correspond to one or more rows of pixels of the second en face feature segmentation 606 (e.g., a single row of pixels, two rows of pixels, etc.). In an example in which each B-scan corresponds to a single vertical pixel of the en face image 504 (and/or each B-scan feature segmentation corresponds to a single vertical pixel of the second en face feature segmentation 606), the section 614 may comprise a single row of pixels, and/or each y-coordinate of the second en face feature segmentation 606 along the y-axis may correspond to a B-scan feature segmentation of the first plurality of B-scan feature segmentations 602. In some examples, for each x coordinate of the section 614 of the second en face feature segmentation 606 along the x-axis, the first translation module 604 may generate a pixel at the x coordinate based upon one or more values, of the first B-scan feature segmentation 506, associated with the x coordinate. For example, a pixel 616 at a first x-coordinate of the section 614 of the second en face feature segmentation 606 may be generated based upon a first set of values (e.g., a column of pixels 610), of the first B-scan feature segmentation 506, corresponding to the first x-coordinate. In an example, the pixel 616 may be generated based upon a maximum value of the first set of values. In some examples, the pixel 616 is generated to indicate no GA (e.g., a value of zero) based upon all of the first set of values being equal to zero. Alternatively and/or additionally, a pixel 618 at a second x-coordinate of the section 614 of the second en face feature segmentation 606 may be generated based upon a second set of values (e.g., a column of pixels 612), of the first B-scan feature segmentation 506, corresponding to the second x-coordinate. In an example, the pixel 618 may be generated based upon a maximum value of the second set of values. In some examples, the pixel 618 is generated to indicate presence of GA (e.g., a value of one) based upon at least one value of the second set of values being equal to one.

In some examples, the ocular evaluation module 510 may comprise a first comparison module 608 to compare the second en face feature segmentation 606 with the first en face feature segmentation 508 and/or generate the enhanced pathological feature segmentation 512 based upon the comparison. There may be one or more differences between the second en face feature segmentation 606 and the first en face feature segmentation 508. The one or more differences may be due, at least in part, to one or more differences in how the trained B-scan model 420 and the trained en face model 440 perform feature detection, and/or one or more differences in how one or more features (e.g., GA and/or hypertransmission) are visually represented in B-scans in comparison with en face images. In some examples, a transmission defect (e.g., hypertransmission defect and/or hypotransmission defect) may be more apparent (and/or more detectable) in an OCT en face image in comparison with an OCT B-scan. Alternatively and/or additionally, a likelihood of the trained en face model 440 being able to successfully identify the transmission defect (and/or another type of pathological feature) using the OCT en face image may be higher than a likelihood of the trained B-scan model 420 being able to successfully identify the transmission defect (and/or another type of pathological feature) using the OCT B-scan.

In some examples, the first comparison module 608 may perform pathological feature isolation (e.g., transmission defect isolation) based upon the second en face feature segmentation 606 and the first en face feature segmentation 508 to isolate a pathological feature (e.g., transmission defect, such as hypertransmission defect and/or hypotransmission defect) that is detected by the trained en face model 440 but not detected by the trained B-scan model 420, and/or may generate a representation of the pathological feature (for inclusion in the enhanced pathological feature segmentation 512, for example). Embodiments are contemplated in which the first comparison module 608 performs pathological feature isolation (e.g., transmission defect isolation) based upon the second en face feature segmentation 606 and the first en face feature segmentation 508 to isolate a pathological feature (e.g., transmission defect, such as hypertransmission defect and/or hypotransmission defect) that is detected by the trained B-scan model 420 but not detected by the trained en face model 440, and/or may generate a representation of the pathological feature (for inclusion in the enhanced pathological feature segmentation 512, for example).

In an example, the first en face feature segmentation 508 may be indicative of a transmission defect lesion 620 (e.g., a hypertransmission defect and/or hypotransmission defect) identified by the trained en face model 440 based upon the en face image 504. Alternatively and/or additionally, the second en face feature segmentation 606 may not identify the transmission defect lesion 620, such as due, at least in part, to the trained B-scan model 420 not being able to detect the transmission defect lesion 620 from B-scans of the set of B-scans 503. The first comparison module 608 may compare the first en face feature segmentation 508 with the second en face feature segmentation 606 to isolate the transmission defect lesion 620, and/or may generate a segmentation 624 of the transmission defect lesion 620 for inclusion in the enhanced pathological feature segmentation 512. Alternatively and/or additionally, the first comparison module 608 may compare the first en face feature segmentation 508 with the second en face feature segmentation 606 to isolate geographic atrophy (GA) (which may be detected by both the trained B-scan model 420 and the trained en face model 440, for example), and/or may generate a segmentation 626 of the GA for inclusion in the enhanced pathological feature segmentation 512.

In some examples, the first comparison module 608 may combine the second en face feature segmentation 606 with the first en face feature segmentation 508 to generate the enhanced pathological feature segmentation 512. For example, the second en face feature segmentation 606 may be summed with the first en face feature segmentation 508 to generate the enhanced pathological feature segmentation 512. Alternatively and/or additionally, the second en face feature segmentation 606 may be compared with the first en face feature segmentation 508 to determine one or more overlap areas (where one or more areas indicated by the second en face feature segmentation 606 overlap with one or more areas indicated by the first en face feature segmentation 508). The enhanced pathological feature segmentation 512 may be generated based upon the one or more overlap areas. In some examples, the enhanced pathological feature segmentation 512 may be generated based upon a specificity level, which may be tuned within a range of specificity levels comprising a lower specificity level (e.g., the enhanced pathological feature segmentation 512 may be generated to include a sum of the second en face feature segmentation 606 and the first en face feature segmentation 508, which may include the one or more overlap areas and/or additional areas indicated by the second en face feature segmentation 606 and/or the first en face feature segmentation 508) and/or a higher specificity level (e.g., the enhanced pathological feature segmentation 512 may be generated to include merely the one or more overlap areas). In some examples, the enhanced pathological feature segmentation 512 may be generated based upon a sensitivity level, which may be tuned within a range of sensitivity levels.

FIG. 6B illustrates an example scenario 651 in which the first comparison module 608 compares en face feature segmentations 632 and 634 to generate a representation 636 identifying an overlapping area with a grid pattern and a non-overlapping area in white. The overlapping area may correspond to an area classified as being associated with a pathological feature (e.g., GA and/or a transmission defect) by both of the en face feature segmentations 632 and 634. The non-overlapping area may correspond to an area that is (i) classified as being associated with the pathological feature (e.g., GA and/or transmission defect) by a first segmentation of the en face feature segmentations 632 and 634 and (ii) not classified as being associated with the pathological feature (e.g., GA and/or transmission defect) by a second segmentation of the en face feature segmentations 632 and 634 (e.g., merely one of the en face feature segmentations 632 and 634 classifies the non-overlapping area as being associated with the pathological feature). The first comparison module 608 may generate the enhanced pathological feature segmentation 512 to include a segmentation 638, of the pathological feature 624 (e.g., GA and/or transmission defect) that comprises the overlapping area identified by the representation 636 and/or at least a portion of the non-overlapping area identified by the representation 636.

In some examples, a multi-threshold control function may be implemented to automatically adjust a confidence score threshold applied to a pixel based upon whether both models (in the case of the overlapping area, for example) or merely a single model (in the case of the non-overlapping area, for example) outputs a determination that the pixel is associated with the pathological feature (e.g., GA and/or transmission defect). For example, the first comparison module 608 (and/or models such as the trained B-scan model 420 and/or the trained en face model 440) may use different confidence score thresholds for different pixels based upon whether they reside in the overlapping area or the non-overlapping area.

In an example, a model (e.g., the trained B-scan model 420 and/or the trained en face model 440) may determine a first confidence score for a non-overlapping pixel residing within the non-overlapping area and a second confidence score for an overlapping pixel residing within the non-overlapping area. The first confidence score and/or the second confidence score may be indicative of a confidence of the model's predictions that the respective pixels correspond to the pathological feature (e.g., GA and/or transmission defect). For example, the first comparison module 608 may determine whether to classify the non-overlapping pixel as being associated with the pathological feature (e.g., GA and/or transmission defect) by applying a first threshold confidence score to the first confidence score associated with the non-overlapping pixel. For example, the non-overlapping pixel may be classified as being associated with the pathological feature based upon the first confidence score meeting (e.g., exceeding) the first threshold confidence score. Alternatively and/or additionally, the first comparison module 608 may determine whether to classify the overlapping pixel as being associated with the pathological feature (e.g., GA and/or transmission defect) by applying a second threshold confidence score to the second confidence score associated with the overlapping pixel. For example, the overlapping pixel may be classified as being associated with the pathological feature based upon the second confidence score meeting (e.g., exceeding) the second threshold confidence score. The first threshold confidence score may be different than (e.g., higher than) the second threshold confidence score. Providing for threshold control according to the overlapping area and/or the non-overlapping area may provide for improved accuracy of the enhanced pathological feature segmentation 512. In some examples, the first threshold confidence score and/or the second threshold confidence score may be adjusted based upon the specificity level (e.g., a higher value of the specificity level may correspond to a higher value of the first threshold confidence score and/or the second threshold confidence score).

In some examples, one or more models (e.g., the trained B-scan model 420 and/or the trained en face model 440) of the system 501 may be updated (e.g., further trained) using feedback information associated with the comparison by the first comparison module 608. For example, the feedback information may be indicative of (i) a difference between the en face feature segmentation 632 and the (enhanced) segmentation 638, (ii) a difference between the en face feature segmentation 634 and the (enhanced) segmentation 638, and/or (iii) the (enhanced) segmentation 638. It may be appreciated that updating and/or training the one or more models based upon the feedback information may create a closed-loop process allowing results of comparison and/or interactions between en face and B-scan models as feedback to tailor settings of the one or more models of the system 501. Closed-loop control may reduce errors and produce more efficient operation of a computer system which implements the system 501. The reduction of errors and/or the efficient operation of the computer system may improve operational stability and/or predictability of operation. Accordingly, using processing circuitry to implement closed loop control described herein may improve operation of underlying hardware of the computer system.

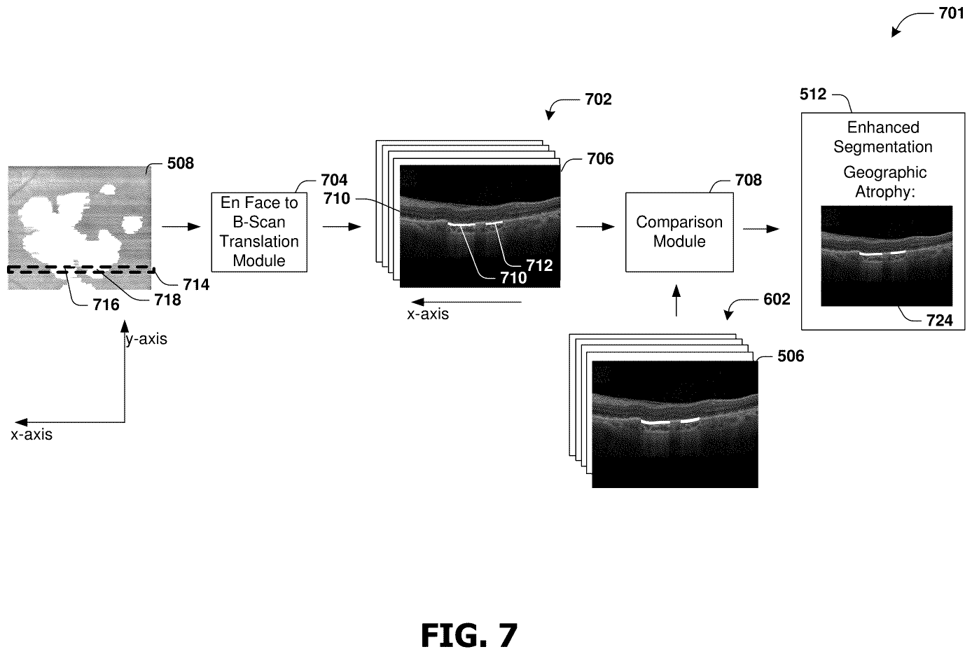

FIG. 7 illustrates an example scenario 701 in which the ocular evaluation module 510 generates a second B-scan feature segmentation 706 based upon the first en face feature segmentation 508, and/or uses the second B-scan feature segmentation 706 (in conjunction with the first B-scan feature segmentation 506, for example) to generate the enhanced pathological feature segmentation 512. In some examples, a second translation module 704 translates one or more areas (of the en face image 504, for example) indicated by the first en face feature segmentation 508 to one or more second areas of the B-scan 502 to generate the second B-scan feature segmentation 706.

Alternatively and/or additionally, the second translation module 704 may generate a second plurality of B-scan feature segmentations 702 based upon the first en face feature segmentation 508. The second plurality of B-scan feature segmentations 702 may comprise the second B-scan feature segmentation 706 associated with the B-scan 502 and/or other B-scan feature segmentations associated with other B-scans of the set of B-scans 503. In an example, each of the second plurality of B-scan feature segmentations 702 may be generated based upon a respective section of the first en face feature segmentation 508. For example, the second B-scan feature segmentation 706 may be generated based upon a section 714 of the first en face feature segmentation 508, another B-scan feature segmentation of the second plurality of B-scan feature segmentations 702 may be generated based upon another section of the first en face feature segmentation 508, etc. In some examples, a pathological area 718 and/or a pathological area 716 of the section 714 of the first en face feature segmentation 508 may be translated to a pathological area 710 and/or a pathological area 712 (e.g., the one or more second areas), respectively, of the B-scan 502 to generate the second B-scan feature segmentation 706. In some examples, the second translation module 704 determines a target ocular zone (e.g., EZ, RPE, BM and/or other ocular zone) and/or projects the section 714 of the first en face feature segmentation 508 onto the target ocular zone relative to the B-scan 502 to generate the second B-scan feature segmentation 706. The target ocular zone may be determined based upon the one or more targeted areas of interest associated with the en face image 504 and/or the first en face feature segmentation 508. For example, the pathological area 710 and/or the pathological area 712 may be generated along the BM of the eye based upon the en face image 504 comprising a visual representation of the BM (e.g., the one or more targeted areas of interest comprise the BM).

In some examples, the ocular evaluation module 510 may comprise a second comparison module 708 to compare the second plurality of B-scan feature segmentations 702 with the first plurality of B-scan feature segmentations 602. In some examples, the second comparison module 708 may perform one, some or all of the actions provided herein with respect to the first comparison module 608 to determine information (e.g., segmentations of one or more pathological features relative to one, some or all of the set of B-scans 503, isolated segmentation information, etc.) for inclusion in the enhanced pathological feature segmentation 512. For example, the second comparison module 708 may compare and/or combine the second B-scan feature segmentation 706 of the second plurality of B-scan feature segmentations 702 with the first B-scan feature segmentation 506 of the first plurality of B-scan feature segmentations 602 to generate an enhanced B-scan feature segmentation 724 for inclusion in the enhanced pathological feature segmentation 512 (such as using one or more of the techniques provided herein with respect to using the first comparison module 608 to generate segmentations 624, 626, 638, etc.). In an example, the second B-scan feature segmentation 706 may be summed with the first B-scan feature segmentation 506 to generate the enhanced B-scan feature segmentation 724. Alternatively and/or additionally, the second B-scan feature segmentation 706 may be compared with the first B-scan feature segmentation 506 to determine one or more overlap areas (where one or more areas indicated by the second B-scan feature segmentation 706 overlap with one or more areas indicated by the first B-scan feature segmentation 506). The enhanced B-scan feature segmentation 724 may be generated based upon the one or more overlap areas. In some examples, the enhanced B-scan feature segmentation 724 may be generated based upon a second specificity level, which may be tuned within a second range of specificity levels comprising a lower specificity level (e.g., the enhanced B-scan feature segmentation 724 may be generated to include a sum of the second B-scan feature segmentation 706 and the first B-scan feature segmentation 506, which may include the one or more overlap areas and/or additional areas indicated by the second B-scan feature segmentation 706 and/or the first B-scan feature segmentation 506) and/or a higher specificity level (e.g., the enhanced B-scan feature segmentation 724 may be generated to include merely the one or more overlap areas).

In some examples, the ocular evaluation module 528 analyzes the enhanced pathological feature segmentation 512 to determine a set of (one or more) parameters. The set of parameters may be usable for diagnosing and/or treating the first person. In an example, the set of parameters may comprise (i) a measure of ellipsoid zone (EZ) loss, (ii) EZ integrity, (iii) a measure (e.g., volume and/or area) of subretinal hyperreflective material (SHRM), (iv) a measure (e.g., volume and/or thickness and/or area) of retinal pigment epithelium (RPE), (v) a measure (e.g., volume and/or thickness and/or area) of geographic atrophy (GA), (vi) a measure (e.g., volume and/or thickness and/or area) of a transmission defect (e.g., hypertransmission defect and/or hypotransmission defect), (vii) a lesion size (e.g., volume and/or thickness and/or area) of a lesion (e.g., at least one of a GA lesion, a transmission defect lesion corresponding to a hypertransmission defect and/or a hypotransmission defect, etc.), (viii) a lesion classification of a lesion (e.g., at least one of a GA lesion, a transmission defect lesion corresponding to a hypertransmission defect and/or a hypotransmission defect, etc.), (ix) a measure (e.g., quantity and/or concentration) of lesions, of the first eye, corresponding to a first lesion classification, (x) a measure (e.g., quantity and/or concentration) of lesions, of the first eye, corresponding to a second lesion classification, (xi) a measure of retinal toxicity (e.g., hydroxychloroquine toxicity and/or chloroquine toxicity in the first person's eye), (xii) a correlation between best corrected visual acuity (BCVA) with one or more other parameters and/or features, (xiii) a measure (e.g., volume) of intraretinal fluid (IRF) (e.g., longintudinal IRF volume), (xiv) a measure (e.g., volume) of subretinal fluid (SRF) (e.g., longintudinal SRF volume), (xv) a measure (e.g., volume and/or area) of Subretinal material (SRMat), (xvi) a measure (e.g., volume and/or area) of drusen, (xvii) pixel-wise measurements (e.g., pixel-wise GA measurements, pixel-wise transmission defect measurements, pixel-wise EZ loss measurements, pixel-wise lesion measurements, pixel-wise SRMat measurements, pixel-wise SHRM measurements, etc.) and/or (xviii) one or more other measures and/or parameters associated with the first person.

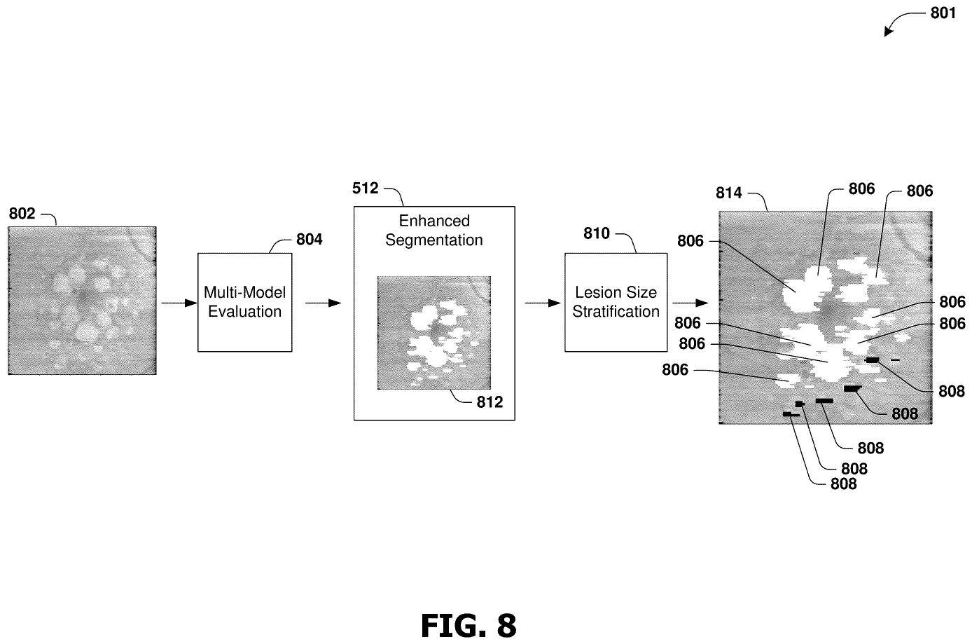

In some examples, the ocular evaluation module 528 may comprise a lesion size stratification module 810 to perform lesion size stratification on the enhanced pathological feature segmentation 512 to determine one or more lesion classifications of one or more lesions at one or more ocular zones of the first eye. In an example scenario 801 of FIG. 8, a multi-model evaluation 804 may be performed on one or more images (e.g., the set of B-scans 503 and/or the set of en face images 505) comprising an en face image 802 to generate an enhanced en face feature segmentation 812 (for inclusion in the enhanced pathological feature segmentation 512, for example). For example, the multi-model evaluation 804 may be performed to generate the enhanced en face feature segmentation 812 (using the trained B-scan model 420 and/or the trained en face model 440, for example) using one or more of the techniques provided herein with respect to (i) using the trained B-scan model 420 and/or the trained en face model 440 to generate one or more en face segmentations and/or one or more B-scan segmentations and/or (ii) comparing and/or combining the one or more en face segmentations with the one or more B-scan segmentations to generate the enhanced pathological feature segmentation 512 (e.g., segmentations 624, 626 and/or 638). The enhanced pathological feature segmentation 512 may identify a set of segments (shown in white in FIG. 8) corresponding to a set of lesions (e.g., at least one of a GA lesion, a transmission defect lesion corresponding to a hypertransmission defect and/or a hypotransmission defect, etc.). The lesion size stratification module 810 may (i) perform automated lesion size stratification on the enhanced en face feature segmentation 812 to determine lesion classifications of the set of lesions, and/or (ii) generate a lesion classification representation 814 based upon the lesion classifications. In some examples, the automated lesion size stratification may comprise (i) identifying a segment, indicated by the enhanced en face feature segmentation 812, corresponding to a lesion of the set of lesions, (ii) measuring the segment to determine a lesion size of the set of lesions, wherein the lesion size may correspond to a diameter of the lesion (e.g., a greatest diameter of the lesion), and/or (iii) comparing the lesion size with one or more lesion size thresholds and/or lesion size ranges to determine a lesion classification, from among a plurality of lesion classifications (e.g., the first lesion classification, the second lesion classification, etc.). In an example, the lesion may be classified as corresponding to the first lesion classification based upon the lesion size meeting (e.g., exceeding) a first lesion size threshold (e.g., 250 micrometers or other value). Alternatively and/or additionally, the lesion may be classified as corresponding to the second lesion classification based upon the lesion size not meeting (e.g., not exceeding) the first lesion size threshold. In an example, the lesion size stratification module 810 may identify a lesion corresponding to the first lesion classification based upon (i) determining that a measure of RPE loss (determined based upon the enhanced en face feature segmentation 812 and/or indicated by the set of parameters, for example) associated with the legion meets (e.g., exceeds) a threshold measure of RPE loss (e.g., the measure of RPE loss may correspond to a greatest diameter of the lesion and/or RPE loss associated with the lesion and/or the threshold measure of RPE loss may be 250 micrometers or other value), (ii) determining that there is phoreceptor loss overlying the lesion, and/or (iii) determining that a measure of a hypertransmission defect (determined based upon the enhanced en face feature segmentation 812 and/or indicated by the set of parameters, for example) associated with the legion meets (e.g., exceeds) a threshold measure of RPE loss (e.g., the measure of the hypertransmission defect may correspond to a greatest diameter of the lesion and/or hypertransmission associated with the lesion and/or the threshold measure of the hypertransmission defect may be 250 micrometers or other value).

In an example, the first lesion classification may correspond to complete atrophy, such as complete RPE and Outer Retinal Atrophy (cRORA). In an example, the second lesion classification may correspond to incomplete atrophy, such as incomplete RPE and Outer Retinal Atrophy (iRORA). The lesion classification representation 814 may be indicative of (i) first segments 806 (shown in white in FIG. 8) corresponding to lesions, of the set of lesions, that are classified as corresponding to the first lesion classification and/or (ii) second segments 808 (shown in black in FIG. 8) corresponding to lesions, of the set of lesions, that are classified as corresponding to the second lesion classification.

In some examples, the ocular evaluation module 528 may analyze the set of parameters and/or the enhanced pathological feature segmentation 512 to (i) diagnose the first person with a first eye condition (e.g., one or more retinal diseases), (ii) determine a progression and/or severity level of the first eye condition, (iii) determine a risk level of the first eye condition and/or (iv) generate a treatment plan for the first person (e.g., a treatment plan for treating the first eye condition). In some examples, a treatment of the first person may be controlled based upon the treatment plan. In an example, the first eye condition may comprise at least one of macular degeneration, age-related macular degeneration (AMD) (e.g., wet AMD and/or dry AMD), diabetic retinopathy, one or more inherited retinal diseases, one or more atrophic eye diseases (e.g., at least one of retinitis pigmentosa, Stargardt disease, etc.), retinal toxicity (e.g., hydroxychloroquine toxicity and/or chloroquine toxicity), and/or one or more other eye conditions.

In some examples, the ocular evaluation module 528 may generate an ocular report based upon the set of parameters, the enhanced pathological feature segmentation 512, the first eye condition, the risk level, the progression and/or severity level and/or the treatment plan. For example, the ocular report may comprise one or more graphical objects (e.g., one or more charts, one or more B-scans, one or more en face images, one or more graphical objects overlaying one or more en face images and/or one or more B-scans, etc.) and/or text indicative of the first eye condition, the risk level, the progression and/or severity level, the treatment plan and/or the enhanced pathological feature segmentation 512 and/or one or more other pathological feature segmentations (e.g., enhanced pathological feature segmentations) generated using one or more of the techniques provided herein with respect to determining the enhanced pathological feature segmentation 512. In some examples, the ocular evaluation module 528 may perform one or more acts of the present disclosure to determine a plurality of enhanced pathological feature segmentations associated with a plurality of pathological features of one or more pathological feature types (e.g., the one or more first pathological feature types and/or the one or more second pathological feature types), such as at least one of GA, a hypertransmission defect, a hypotransmission defect, drusen, inflammatory lesion, SHRM, SRMat, EZ loss, IRF (e.g., longitudinal IRF), SRF (e.g., longitudinal SRF), cystic fluid, general fluid, sub-RPE fluid, a lesion, etc. In some examples, the ocular evaluation module 528 may generate the ocular report to include one or more representations of some or all of the plurality of enhanced pathological feature segmentations. Alternatively and/or additionally, the ocular report may comprise a representation that visually identifies a position of a pathological feature segmentation (of the plurality of enhanced pathological feature segmentations) relative to one or more ocular zone segmentations (e.g., segmentations identifying one or more ocular zones comprising at least one of an ILM, a BM, a RPE, an ONL, an EZ, POS, ELM, an OPL, an INL, an IPL, a GCL, a RNFL, etc. of the first eye). For example, the pathological feature segmentation may be displayed in association with (e.g., overlaid onto and/or adjacent to) the one or more ocular zone segmentations (so a viewer can ascertain a position, size, etc. of a pathological feature represented by the pathological feature segmentation, for example).

In an example, the ocular report may comprise a representation of the enhanced pathological feature segmentation 512, which may comprise one or more pathological feature segments (corresponding to one or more pathological features of the first eye) overlaid onto an image, such as a B-scan or an en face image, of the first eye of the first person. The ocular report may comprise one or more representations of segmentations 624, 626, 638, 724 and/or 812. Alternatively and/or additionally, the ocular report may comprise representations 636 and/or 814.

In some examples, the ocular report may be transmitted to a client device (e.g., at least one of a phone, a tablet, a laptop, a computer, a wearable device, a smart device, a television, any other type of computing device, hardware and/or software) and/or displayed via a graphical user interface. For example, the ocular report may be displayed to one or more healthcare professionals (e.g., physician, surgeon, nurse, etc.) that are associated with the treatment of the first person. For example, the ocular report may provide a healthcare professional with information about the first person's response to the treatment (e.g., whether the first eye condition of the first person is improving or worsening) that can enable the healthcare professional to have an improved understanding of an effectiveness of the treatment thus far and/or make a more informed decision of one or more next steps of the treatment. Alternatively and/or additionally, the ocular report may enable the one or more healthcare professionals to detect the first eye condition of the first person more quickly and/or sooner, which may allow the one or more healthcare professionals to begin treating the first eye condition at an earlier stage such that the treatment is more effective (than if the first eye condition was detected and/or treated at a later stage, for example).

In some examples, the ocular report may display one or more en face images (e.g., one or more images of the set of en face images 505) and/or one or more en face segmentations (e.g., segmentations 624, 626, 606, 508, 632, 634, 638, etc.) overlaying the one or more en face images. The one or more en face images and/or the one or more en face segmentations may enable a healthcare professional to evaluate pathological features of the eye (e.g., pathological features associated with an eye condition, such as AMD, an inherited retinal disease, etc.) over two lateral dimensions (rather than a single horizontal dimension corresponding to an OCT B-scan, for example), which may be more interpretable to the healthcare professional and/or may provide for improved understanding by the healthcare professional of the first eye condition.

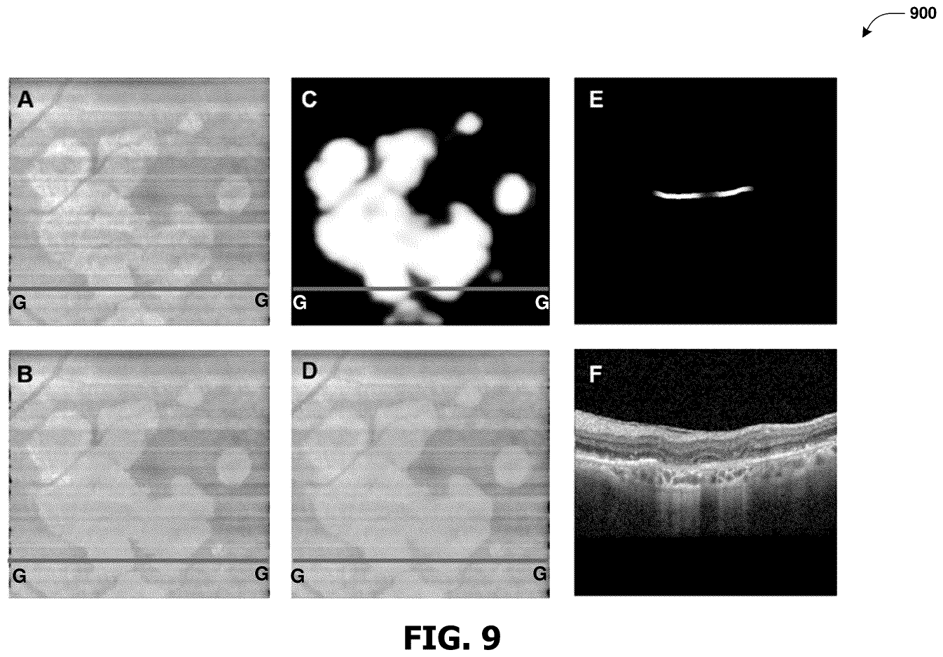

FIG. 9 illustrates an example representation 900 of at least a portion of the ocular report. The example representation 900 is associated with en face model performance of the trained en face model 440. Image A of the example representation 900 shows a model training input image (e.g., included in the plurality of en face images 422). Image B of the example representation 900 shows a ground truth mask (e.g., included in the plurality of ground truth masks 430). Image C of the example representation 900 shows a grayscale output from the trained en face model 440. Pixel values of pixels of Image C may be based upon confidence scores associated with predictions, by the trained en face model 440, of whether a given pixel corresponds to the one or more second pathological feature types. Image D of the example representation 900 shows a binary output mask from the trained en face model 440 (generated by applying one or more thresholds to pixel values and/or confidence scores of Image C, for example) showing excellent concordance to the ground truth mask shown in Image B. Images E and F of the example representation 900 show projection of the en face model prediction onto an OCT B-scan BM line for GA area prediction. Line GG in images A, B, C and D may identify a position of the B-scan.

In some examples, each machine learning model of one, some and/or all machine learning models of the present disclosure (e.g., the trained B-scan model 420 and/or the trained en face model 440, a machine learning model used by the ocular zone segmentation module 446 to perform ocular zone segmentation, etc.) may be configured for biomedical image segmentation and/or may comprise at least one of a neural network, such as a convolutional neural network (e.g., a convolutional neural network with a deep learning U-net architecture), a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc.

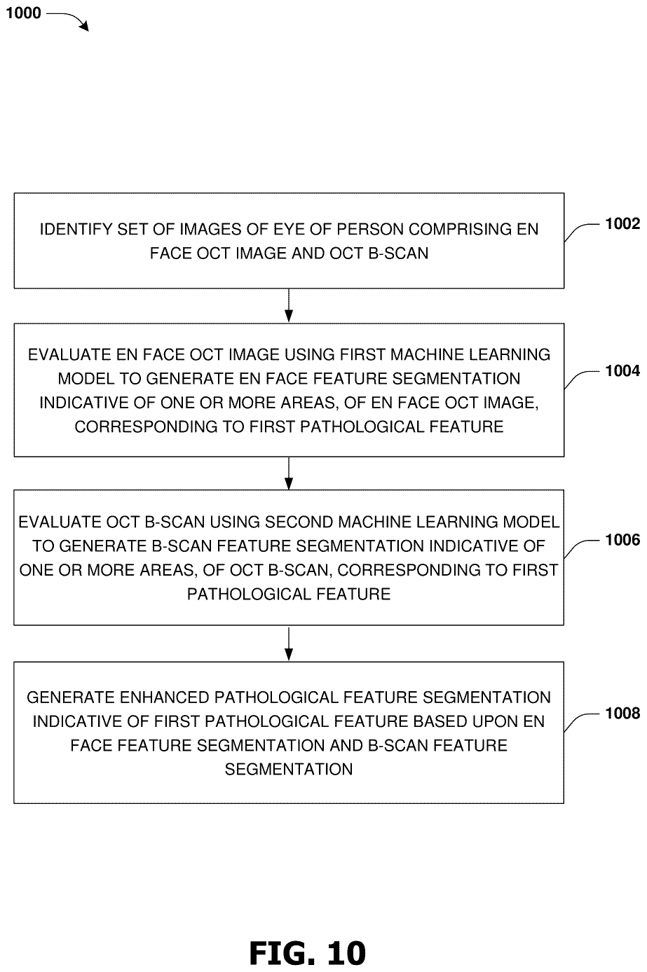

An embodiment of generating an enhanced pathological feature segmentation is illustrated by an example method 1000 of FIG. 10. At 1002, a set of (one or more) images (e.g., the set of B-scans 503 and/or the set of en face images 505) of an eye of a person may be received. The set of images may comprise an en face OCT image (e.g., the en face image 504) and/or an OCT B-scan (e.g., the B-scan 502). At 1004, a first machine learning model (e.g., the trained en face model 440) may be used to evaluate the en face OCT image to generate an en face feature segmentation (e.g., the first en face feature segmentation 508) corresponding to one or more first pathological features (e.g., GA and/or hypertransmission). At 1006, a second machine learning model (e.g., the trained B-scan model 420) may be used to evaluate the OCT B-scan to generate a B-scan feature segmentation (e.g., the first B-scan feature segmentation 506) corresponding to one or more second pathological features (e.g., GA and/or hypertransmission). In some examples, one, some or all of the one or more second pathological features identified by the second machine learning model may be the same as one, some or all of the one or more first pathological features identified by the first machine learning model. At 1008, an enhanced pathological feature segmentation (e.g., the enhanced pathological feature segmentation 512) may be generated based upon the en face feature segmentation and/or the B-scan feature segmentation. The enhanced pathological feature segmentation may be indicative of one, some or all pathological features of the one or more first pathological features and/or the one or more second pathological features.

According to some embodiments, a computer-implemented method is provided. The computer-implemented method includes identifying a set of images of an eye of a person comprising an en face optical coherence tomography (OCT) image and an OCT Brightness-scan (B-scan); evaluating the en face OCT image using a first machine learning model to generate a first en face feature segmentation indicative of one or more areas, of the en face OCT image, corresponding to a first pathological feature; evaluating the OCT B-scan using a second machine learning model to generate a first B-scan feature segmentation indicative of one or more areas, of the OCT B-scan, corresponding to the first pathological feature; and generating an enhanced pathological feature segmentation indicative of the first pathological feature based upon the first en face feature segmentation and the first B-scan feature segmentation.

According to some embodiments, generating the enhanced pathological feature segmentation includes generating, based upon the first en face feature segmentation, a second B-scan feature segmentation indicative of one or more second areas, of the OCT B-scan, corresponding to the first pathological feature; and comparing the second B-scan feature segmentation with the first B-scan feature segmentation.

According to some embodiments, generating the second B-scan feature segmentation includes translating the one or more areas, of the en face OCT image, indicated by the first en face feature segmentation to the one or more second areas of the OCT B-scan.

According to some embodiments, the comparison includes determining one or more overlap areas where the one or more second areas indicated by the second B-scan feature segmentation overlap with the one or more areas indicated by the first B-scan feature segmentation; and the enhanced pathological feature segmentation is generated based upon the one or more overlap areas.

According to some embodiments, generating the enhanced pathological feature segmentation includes combining the second B-scan feature segmentation with the first B-scan feature segmentation to generate the enhanced pathological feature segmentation.

According to some embodiments, generating the enhanced pathological feature segmentation includes generating, based upon the first B-scan feature segmentation, a second en face feature segmentation indicative of one or more second areas, of the en face OCT image, corresponding to the first pathological feature; and comparing the second en face feature segmentation with the en face OCT image.

According to some embodiments, generating the second en face feature segmentation includes translating the one or more areas, of the OCT B-scan, indicated by the first B-scan feature segmentation to the one or more second areas of the en face OCT image.

According to some embodiments, the comparison includes determining one or more overlap areas where the one or more second areas indicated by the second en face feature segmentation overlap with the one or more areas indicated by the first en face feature segmentation; and the enhanced pathological feature segmentation is generated based upon the one or more overlap areas.

According to some embodiments, generating the enhanced pathological feature segmentation includes combining the second en face feature segmentation with the first en face feature segmentation to generate the enhanced pathological feature segmentation.

According to some embodiments, the computer-implemented method includes identifying a plurality of en face OCT images associated with a plurality of persons; generating a plurality of en face ground truth masks associated with the plurality of en face OCT images, wherein an en face ground truth mask of the plurality of en face ground truth masks is indicative of one or more areas, of a second en face OCT image, corresponding to the first pathological feature; and training a machine learning model using the plurality of en face OCT images and the plurality of en face ground truth masks to generate the first machine learning model.

According to some embodiments, the computer-implemented method includes identifying a plurality of OCT B-scans associated with a plurality of persons; generating a plurality of B-scan ground truth masks associated with the plurality of OCT B-scans, wherein a B-scan ground truth mask of the plurality of B-scan ground truth masks is indicative of one or more areas, of a second OCT B-scan of the plurality of OCT B-scans, corresponding to the first pathological feature; and training a machine learning model using the plurality of OCT B-scans and the plurality of B-scan ground truth masks to generate the second machine learning model.

According to some embodiments, training the machine learning model includes evaluating the second OCT B-scan to generate a segmentation profile indicative of a plurality of segments corresponding to a plurality of ocular zones; analyzing the segmentation profile to identify a region in which two or more segments of the plurality of segments are confluent; and generating the B-scan ground truth mask based upon the region.

According to some embodiments, the two or more segments comprise at least one of ellipsoid zone (EZ); retinal pigment epithelium (RPE); or Bruch's membrane (BM).

According to some embodiments, the first pathological feature includes a lesion, at one or more ocular zones of the eye, associated with at least one of geographic atrophy (GA), a hypertransmission defect, a hypotransmission defect, drusen, inflammation, subretinal material (SRMat), subretinal hyperreflective material (SHRM) or ellipsoid zone (EZ) loss.

According to some embodiments, the computer-implemented method includes determining, based upon the enhanced pathological feature segmentation, one or more parameters usable for at least one of diagnosing or treating the person.

According to some embodiments, the first pathological feature includes a lesion; and determining the one or more parameters comprises performing automated lesion size stratification to determine a lesion classification of the lesion based upon the enhanced pathological feature segmentation.

According to some embodiments, the computer-implemented method includes generating an ocular report indicative of the enhanced pathological feature segmentation and/or the one or more parameters; and providing the ocular report to a device for display.

According to some embodiments, a non-transitory computer-readable medium is provided. The non-transitory computer-readable medium stores instructions that when executed perform operations including identifying a set of images of an eye of a person comprising an en face optical coherence tomography (OCT) image and an OCT Brightness-scan (B-scan); evaluating the en face OCT image using a first machine learning model to generate an en face feature segmentation indicative of one or more areas, of the en face OCT image, corresponding to a first pathological feature; evaluating the OCT B-scan using a second machine learning model to generate a B-scan feature segmentation indicative of one or more areas, of the OCT B-scan, corresponding to the first pathological feature; and generating an enhanced pathological feature segmentation indicative of the first pathological feature based upon the en face feature segmentation and the B-scan feature segmentation.

According to some embodiments, the operations include determining, based upon the enhanced pathological feature segmentation, one or more parameters usable for at least one of diagnosing or treating the person.

According to some embodiments, a computing device is provided. The computing device includes a processor and memory including processor-executable instructions that when executed by the processor cause performance of operations. The operations include identifying a set of images of an eye of a person comprising an en face optical coherence tomography (OCT) image and an OCT Brightness-scan (B-scan); evaluating the en face OCT image using a first machine learning model to generate an en face feature segmentation indicative of one or more areas, of the en face OCT image, corresponding to a first pathological feature; evaluating the OCT B-scan using a second machine learning model to generate a B-scan feature segmentation indicative of one or more areas, of the OCT B-scan, corresponding to the first pathological feature; and generating an enhanced pathological feature segmentation indicative of the first pathological feature based upon the en face feature segmentation and the B-scan feature segmentation.

According to some embodiments, the operations include determining, based upon the enhanced pathological feature segmentation, one or more parameters usable for at least one of diagnosing or treating the person.

According to some embodiments, a method including at least one aspect as described in the present disclosure and/or shown in the figures.

According to some embodiments, a method including plural aspects as described in the present disclosure and/or shown in the figures.

According to some embodiments, a system including at least one aspect as described in the present disclosure and/or shown in the figures.

According to some embodiments, a system including plural aspects as described in the present disclosure and/or shown in the figures.

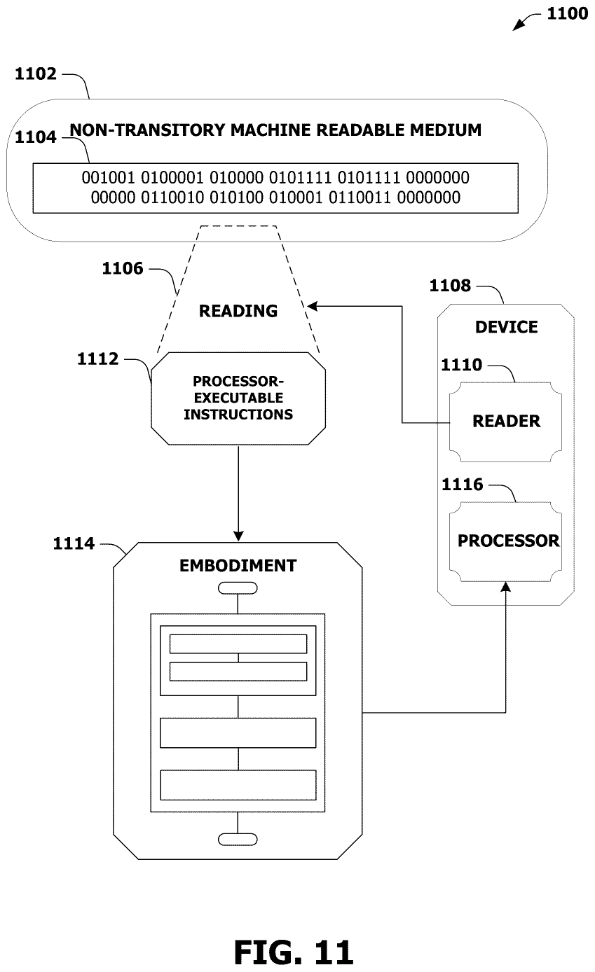

FIG. 11 is an illustration of a scenario 1100 involving an example non-transitory machine readable medium 1102. The non-transitory machine readable medium 1102 may comprise processor-executable instructions 1112 that when executed by a processor 1116 cause performance (e.g., by the processor 1116) of at least some of the provisions herein (e.g., embodiment 1114).

The non-transitory machine readable medium 1102 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk).

The example non-transitory machine readable medium 1102 stores computer-readable data 1104 that, when subjected to reading 1106 by a reader 1110 of a device 1108 (e.g., a read head of a hard disk drive, or a read operation invoked on a solid-state storage device), express the processor-executable instructions 1112.

In some embodiments, the processor-executable instructions 1112, when executed, cause performance of operations, such as at least some of the example method 1000 of FIG. 10, for example. In some embodiments, the processor-executable instructions 1112 are configured to cause implementation of a system, such as at least some of the example machine learning model training system 401 of FIGS. 4A-4F and/or the example system 501 of FIG. 5, for example.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A computer-implemented method, comprising:
identifying a set of images of an eye of a person comprising an en face optical coherence tomography (OCT) image and an OCT Brightness-scan (B-scan);
evaluating the en face OCT image using a first machine learning model to generate a first en face feature segmentation indicative of one or more areas, of the en face OCT image, corresponding to a first pathological feature;
evaluating the OCT B-scan using a second machine learning model to generate a first B-scan feature segmentation indicative of one or more areas, of the OCT B-scan, corresponding to the first pathological feature; and
generating an enhanced pathological feature segmentation indicative of the first pathological feature based upon the first en face feature segmentation and the first B-scan feature segmentation.

2. The computer-implemented method of claim 1, wherein generating the enhanced pathological feature segmentation comprises:
generating, based upon the first en face feature segmentation, a second B-scan feature segmentation indicative of one or more second areas, of the OCT B-scan, corresponding to the first pathological feature; and
comparing the second B-scan feature segmentation with the first B-scan feature segmentation.

3. The computer-implemented method of claim 2, wherein generating the second B-scan feature segmentation comprises:
translating the one or more areas, of the en face OCT image, indicated by the first en face feature segmentation to the one or more second areas of the OCT B-scan.

4. The computer-implemented method of claim 2, wherein:
the comparison comprises determining one or more overlap areas where the one or more second areas indicated by the second B-scan feature segmentation overlap with the one or more areas indicated by the first B-scan feature segmentation; and
the enhanced pathological feature segmentation is generated based upon the one or more overlap areas.

5. The computer-implemented method of claim 2, wherein generating the enhanced pathological feature segmentation comprises:
combining the second B-scan feature segmentation with the first B-scan feature segmentation to generate the enhanced pathological feature segmentation.

6. The computer-implemented method of claim 1, wherein generating the enhanced pathological feature segmentation comprises:
generating, based upon the first B-scan feature segmentation, a second en face feature segmentation indicative of one or more second areas, of the en face OCT image, corresponding to the first pathological feature; and
comparing the second en face feature segmentation with the en face OCT image.

7. The computer-implemented method of claim 6, wherein generating the second en face feature segmentation comprises:
translating the one or more areas, of the OCT B-scan, indicated by the first B-scan feature segmentation to the one or more second areas of the en face OCT image.

8. The computer-implemented method of claim 6, wherein:
the comparison comprises determining one or more overlap areas where the one or more second areas indicated by the second en face feature segmentation overlap with the one or more areas indicated by the first en face feature segmentation; and
the enhanced pathological feature segmentation is generated based upon the one or more overlap areas.

9. The computer-implemented method of claim 6, wherein generating the enhanced pathological feature segmentation comprises:
combining the second en face feature segmentation with the first en face feature segmentation to generate the enhanced pathological feature segmentation.

10. The computer-implemented method of claim 1, comprising:
identifying a plurality of en face OCT images associated with a plurality of persons;
generating a plurality of en face ground truth masks associated with the plurality of en face OCT images, wherein an en face ground truth mask of the plurality of en face ground truth masks is indicative of one or more areas, of a second en face OCT image of the plurality of en face OCT images, corresponding to the first pathological feature; and
training a machine learning model using the plurality of en face OCT images and the plurality of en face ground truth masks to generate the first machine learning model.

11. The computer-implemented method of claim 1, comprising:
identifying a plurality of OCT B-scans associated with a plurality of persons;
generating a plurality of B-scan ground truth masks associated with the plurality of OCT B-scans, wherein a B-scan ground truth mask of the plurality of B-scan ground truth masks is indicative of one or more areas, of a second OCT B-scan of the plurality of OCT B-scans, corresponding to the first pathological feature; and
training a machine learning model using the plurality of OCT B-scans and the plurality of B-scan ground truth masks to generate the second machine learning model.

12. The computer-implemented method of claim 11, wherein training the machine learning model comprises:
evaluating the second OCT B-scan to generate a segmentation profile indicative of a plurality of segments corresponding to a plurality of ocular zones;
analyzing the segmentation profile to identify a region in which two or more segments of the plurality of segments are confluent; and
generating the B-scan ground truth mask based upon the region.

13. The computer-implemented method of claim 12, wherein the two or more segments comprise at least one of:
ellipsoid zone (EZ);
retinal pigment epithelium (RPE); or
Bruch's membrane (BM).

14. The computer-implemented method of claim 1, wherein:
the first pathological feature comprises a lesion, at one or more ocular zones of the eye, associated with at least one of geographic atrophy (GA), a hypertransmission defect, a hypotransmission defect, drusen, inflammation, subretinal material (SRMat), subretinal hyperreflective material (SHRM) or ellipsoid zone (EZ) loss.

15. The computer-implemented method of claim 1, comprising:
determining, based upon the enhanced pathological feature segmentation, one or more parameters usable for at least one of diagnosing or treating the person.

16. The computer-implemented method of claim 15, wherein:
the first pathological feature comprises a lesion; and
determining the one or more parameters comprises performing automated lesion size stratification to determine a lesion classification of the lesion based upon the enhanced pathological feature segmentation.

17. The computer-implemented method of claim 15, comprising:
generating an ocular report indicative of at least one of:
the enhanced pathological feature segmentation; or
the one or more parameters; and
providing the ocular report to a device for display.

18. A non-transitory computer-readable medium storing instructions that when executed perform operations comprising:
identifying a set of images of an eye of a person comprising an en face optical coherence tomography (OCT) image and an OCT Brightness-scan (B-scan);
evaluating the en face OCT image using a first machine learning model to generate an en face feature segmentation indicative of one or more areas, of the en face OCT image, corresponding to a first pathological feature;
evaluating the OCT B-scan using a second machine learning model to generate a B-scan feature segmentation indicative of one or more areas, of the OCT B-scan, corresponding to the first pathological feature; and
generating an enhanced pathological feature segmentation indicative of the first pathological feature based upon the en face feature segmentation and the B-scan feature segmentation.

19. The non-transitory computer-readable medium of claim 18, the operations comprising:
determining, based upon the enhanced pathological feature segmentation, one or more parameters usable for at least one of diagnosing or treating the person.

20. A computing device comprising:
a processor; and
memory comprising processor-executable instructions that when executed by the processor cause performance of operations, the operations comprising:
identifying a set of images of an eye of a person comprising an en face optical coherence tomography (OCT) image and an OCT Brightness-scan (B-scan);
evaluating the en face OCT image using a first machine learning model to generate an en face feature segmentation indicative of one or more areas, of the en face OCT image, corresponding to a first pathological feature;
evaluating the OCT B-scan using a second machine learning model to generate a B-scan feature segmentation indicative of one or more areas, of the OCT B-scan, corresponding to the first pathological feature; and
generating an enhanced pathological feature segmentation indicative of the first pathological feature based upon the en face feature segmentation and the B-scan feature segmentation.

21-29. (canceled)
